(19) United States
(12) Patent Application Publication
(10) Pub. No.: US 2024/0409723 A1
(43) Pub. Date: Dec. 12, 2024

(54) ARTICLES CONTAINING MELT PROCESSABLE CELLULOSE ACETATE COMPOSITIONS COMPRISING ALKALINE FILLER

(71) Applicant: Eastman Chemical Company, Kingsport, TN (US)

(72) Inventors: Stephanie Kay Clendennen, Kingsport, TN (US); Yichen Fang, Piney Flats, TN (US)

(73) Assignee: Eastman Chemical Company, Kingsport, TN (US)

(21) Appl. No.: 18/698,998

(22) PCT Filed: Oct. 7, 2022
(86) PCT No.: PCT/US2022/045991

§ 371 Date: Apr. 5, 2024

Related U.S. Application Data
(60) Provisional application No. 63/262,257, filed on Oct. 8, 2021.
(60) Provisional application No. 63/262,256, filed on Oct. 8, 2021.
(60) Provisional application No. 63/262,255, filed on Oct. 8, 2021.
(60) Provisional application No. 63/262,254, filed on Oct. 8, 2021.

(51) Int. Cl. C08L 1/12; C08K 3/22; C08K 3/26

(52) U.S. Cl. CPC C08L 1/12; C08K 3/22; C08K 3/26; C08K 2003/222; C08K 2003/265; C08L 2201/06; C08L 2207/20

(57) ABSTRACT

The present application discloses melt processable cellulose ester compositions comprising a cellulose ester, at least one alkaline additive, and at least one neutralizing agent. Plasticizers can be optionally used in the compositions. The present application also discloses processes for preparing the compositions and articles that can be made from the compositions. The compositions show improved degradation properties.

### BACKGROUND OF THE INVENTION

There is a well-known global issue with waste disposal, particularly of large volume consumer products such as plastics or polymers that are not considered biodegradable within acceptable temporal limits. There is a public desire to incorporate these types of wastes into renewed products through recycling, reuse, or otherwise reducing the amount of waste in circulation or in landfills. This is especially true for single-use plastic articles/materials.

As consumer sentiment regarding the environmental fate of single-use plastics, such as straws, to-go cups, and plastic bags, are becoming a global trend, plastics bans are being considered/enacted around the world in both developed and developing nations. Bans have extended from plastic shopping bags into straws, cutlery, and clamshell packaging, for example, in the US alone. Other countries have taken even more extreme steps, such as the list of ten single-use articles slated to be banned, restricted in use, or mandated to have extended producer responsibilities throughout the EU. As a result, industry leaders, brand owners, and retailers have made ambitious commitments to implement recyclable, reusable or compostable packaging in the coming years. While recyclable materials are desirable in some applications, other applications lend themselves better to materials that are compostable and/or biodegradable, such as when the article is contaminated with food or when there are high levels of leakage into the environment due to inadequate waste management systems.

Single-use plastic articles are frequently used in food service, intended to be used once for storing or serving food, after which the articles are discarded. To prevent the persistence of these articles it is desirable for the articles to disintegrate and biodegrade, even thicker parts like cup rims and utensils. Disintegration in compost is an end-of life fate that would re-direct these single-use plastic articles from landfill. Single-use plastic articles can range in thickness from less than 5 mil (e.g. straws) to greater than 100 mil (e.g. utensils). For some materials, the rate of disintegration in compost is proportional to the article thickness, i.e. thicker articles take longer to disintegrate, or may not disintegrate within that standard time frame of the composting cycle.

It is desirable to have articles made from biobased materials that have been formulated to disintegrate in compost, even when the articles are 30 mil thick or greater. Furthermore, the appearance of the articles should be suitable for the application (not dark in color and not opaque).

Therefore, there is a market need for single-use consumer products that have adequate performance properties for their intended use and that are compostable and/or biodegradable.

It would be beneficial to provide products having such properties and that also have significant content of renewable, recycled, and/or re-used material.

### SUMMARY OF THE INVENTION

The present application discloses a melt processable cellulose ester composition comprising:
at least one cellulose ester, at least one alkaline additive, and at least one neutralizing agent; wherein a 1 weight % suspension of said alkaline addition has a pH of 8 or greater; wherein the water-solubility of the alkaline filler at 20-25° C. is greater than 1 ppm but less than 1,000 ppm; and wherein the alkaline filler is present in an amount of about 0.1 weight % to about 35 weight % based on the weight of the cellulose ester composition; or
at least one cellulose acetate, at least one plasticizer, at least one alkaline additive, and at least one neutralizing agent; wherein a 1 weight % suspension of said alkaline addition has a pH of 8 or greater; wherein the water-solubility of the alkaline filler at 20-25° C. is greater than 1 ppm but less than 1,000 ppm; and wherein said alkaline filler is present in an amount of about 0.1 weight % to about 35 weight % based on the weight of the cellulose acetate composition.

The application discloses a process to produce a melt processable cellulose ester composition. The process comprises contacting at least one cellulose ester, optionally at least one plasticizer, at least one alkaline additive, and at least one neutralizing agent; wherein a 1 weight % suspension of the alkaline addition has a pH of 8 or greater; wherein the water-solubility of the alkaline filler at 20-25° C. is greater than 1 ppm but less than 1,000 ppm; and wherein the alkaline filler is present in an amount of about 0.1 weight % to about 35 weight % based on the weight of the cellulose ester composition.

The application discloses a process to produce a melt processable cellulose acetate composition. The process comprises contacting at least one cellulose acetate, at least one plasticizer, at least one alkaline additive, and at least one neutralizing agent; wherein a 1 weight % suspension of the alkaline addition has a pH of 8 or greater; wherein the water-solubility of the alkaline filler at 20-25° C. is greater than 1 ppm but less than 1,000 ppm; and wherein the alkaline filler is present in an amount of about 0.1 weight % to about 35 weight % based on the weight of the cellulose acetate composition.

The application discloses an article comprising a melt processable cellulose ester composition; wherein said cellulose ester composition comprises:
at least one cellulose ester, at least one alkaline additive, and at least one neutralizing agent; wherein a 1 weight % suspension of the alkaline addition has a pH of 8 or greater; wherein the water-solubility of the alkaline filler at 20-25° C. is greater than 1 ppm but less than 1,000 ppm; and wherein the alkaline filler is present in an amount of about 0.1 weight % to about 35 weight % based on the weight of the cellulose ester composition; or
at least one cellulose acetate, at least one plasticizer, at least one alkaline additive, and at least one neutralizing agent; wherein a 1 weight % suspension of the alkaline addition has a pH of 8 or greater; wherein the water-solubility of the alkaline filler at 20-25° C. is greater than 1 ppm but less than 1,000 ppm; and wherein the alkaline filler is present in an amount of about 0.1 weight % to about 35 weight % based on the weight of the cellulose acetate composition.

The application discloses a cellulose acetate tow band is provided comprising a cellulose acetate composition; at least one cellulose acetate, at least one plasticizer, at least one alkaline additive, and at least one neutralizing agent; wherein a 1 weight % suspension of the alkaline addition has a pH of 8 or greater; wherein the water-solubility of the alkaline filler at 20-25° C. is greater than 1 ppm but less than 1,000 ppm; and wherein the alkaline filler is present in an amount of about 0.1 weight % to about 35 weight % based on the weight of the cellulose acetate composition.

### DETAILED DESCRIPTION OF THE INVENTION

The present application discloses, a melt processable cellulose ester composition is provided comprising:
at least one cellulose ester, at least one alkaline additive, and at least one neutralizing agent; wherein a 1 weight % suspension of the alkaline addition has a pH of 8 or greater; wherein the water-solubility of the alkaline filler at 20-25° C. is greater than 1 ppm but less than 1,000 ppm; and wherein the alkaline filler is present in an amount of about 0.1 weight % to about 35 weight % based on the weight of the cellulose ester composition or
at least one cellulose acetate, at least one plasticizer, at least one alkaline additive, and at least one neutralizing agent; wherein a 1 weight % suspension of the alkaline addition has a pH of 8 or greater; wherein the water-solubility of the alkaline filler at 20-25° C. is greater than 1 ppm but less than 1,000 ppm and wherein the alkaline filler is present in an amount of about 0.1 weight % to about 35 weight % based on the weight of the cellulose acetate composition.

### Cellulose Ester

The cellulose ester utilized in this invention can be any that is known in the art. Cellulose ester that can be used for the present invention generally comprise repeating units of the structure:

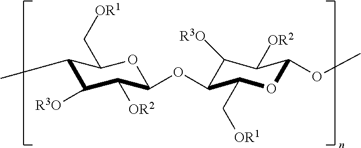

wherein R¹, R², and R³ are selected independently from the group consisting of hydrogen acetyl, propyl or butyl. The substitution level of the cellulose ester is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substitutent. In some cases, there can be unsubstituted anhydroglucose units, some with two and some with three substitutents, and typically the value will be a non-integer. Total DS is defined as the average number of all of substituents per anhydroglucose unit. The degree of substitution per AGU can also refer to a particular substitutent, such as, for example, hydroxyl or acetyl. In embodiments, n is an integer in a range from 25 to 250, or 25 to 200, or 25 to 150, or 25 to 100, or 25 to 75.

In embodiments of the invention, the cellulose esters have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose ester. In embodiments, cellulose esters can have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In embodiments, cellulose esters useful herein can have a DS/AGU of about 1 to about 2.5, or 1 to less than 2.2, or 1 to less than 1.5, and the substituting ester is acetyl.

Cellulose esters can be produced by any method known in the art. Examples of processes for producing cellulose esters are taught in Kirk-Othmer, Encyclopedia of Chemical Technology, 5th Edition, Vol. 5, Wiley-Interscience, New York (2004), pp. 394-444. Cellulose, the starting material for producing cellulose esters, can be obtained in different grades and sources such as from cotton linters, softwood pulp, hardwood pulp, corn fiber and other agricultural sources, and bacterial cellulose, among others.

One method of producing cellulose esters is esterification of the cellulose by mixing cellulose with the appropriate organic acids, acid anhydrides, and catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester can then be washed with water to remove reaction by-products followed by dewatering and drying.

The cellulose triesters to be hydrolyzed can have three acetyl substituents. These cellulose esters can be prepared by a number of methods known to those skilled in the art. For example, cellulose esters can be prepared by heterogeneous acylation of cellulose in a mixture of carboxylic acid and anhydride in the presence of a catalyst such as H₂SO₄. Cellulose triesters can also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituents can be removed by hydrolysis or by alcoholysis to give a secondary cellulose ester. As noted previously, depending on the particular method employed, the distribution of the acyl substituents can be random or non-random. Secondary cellulose esters can also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, or in combination with any of the mentioned embodiments, the cellulose acetates are cellulose diacetates that have a polystyrene equivalent number average molecular weight (Mn) from about 10,000 to about 100,000 as measured by gel permeation chromatography (GPC) using NMP as solvent and polystyrene equivalent Mn according to ASTM D6474. In embodiments, the cellulose acetate composition comprises cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

The cellulose esters useful in the present invention can be prepared using techniques known in the art, and can be chosen from various types of cellulose esters, such as for example the cellulose esters that can be obtained from Eastman Chemical Company, Kingsport, TN, U.S.A., e.g., Eastman™ Cellulose Acetate CA 398-30 and Eastman™ Cellulose Acetate CA 398-10, Eastman™ CAP 485-20 cellulose acetate propionate; Eastman™ CAB 381-2 cellulose acetate butyrate.

In embodiments of the invention, the cellulose ester can be prepared by converting cellulose to a cellulose ester with reactants that are obtained from recycled materials, e.g., a recycled plastic content syngas source. In embodiments, such reactants can be cellulose reactants that include organic acids and/or acid anhydrides used in the esterification or acylation reactions of the cellulose, e.g., as discussed herein.

In one embodiment or in combination with any of the mentioned embodiments, or in combination with any of the mentioned embodiments, of the invention, a cellulose ester composition comprising at least one recycle cellulose ester is provided, wherein the cellulose ester has at least one substituent on an anhydroglucose unit (AU) derived from recycled content material, e.g., recycled plastic content syngas.

### Plasticizer

In one embodiment or in combination with any other embodiment, the melt processable and biodegradable cellulose ester composition can comprise at least one plasticizer. The plasticizer reduces the melt temperature, the Tg, and/or the melt viscosity of the cellulose ester. Plasticizers for cellulose esters may include glycerol triacetate (Triacetin), glycerol diacetate, dibutyl terephthalate, dimethyl phthalate, diethyl phthalate, poly(ethylene glycol) MW 200-600, triethylene glycol dipropionate, 1,2-epoxypropylphenyl ethylene glycol, 1,2-epoxypropyl(m-cresyl) ethylene glycol, 1,2-epoxypropyl(o-cresyl) ethylene glycol, β-oxyethyl cyclohexenecarboxylate, bis(cyclohexanate) diethylene glycol, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, triethyl citrate, acetyl triethyl citrate, polyethylene glycol, the benzoate containing plasticizers such as the Benzoflex™ plasticizer series, poly(alkyl succinates) such as poly(butyl succinate), polyethersulfones, adipate based plasticizers, soybean oil epoxides such as the Paraplex™ plasticizer series, sucrose based plasticizers, dibutyl sebacate, tributyrin, tripropionin, sucrose acetate isobutyrate, the Resolflex™ series of plasticizers, triphenyl phosphate, glycolates, methoxy polyethylene glycol, 2,2,4-trimethylpentane-1,3-diyl bis(2-methylpropanoate), and polycaprolactones.

In one embodiment or in combination with any other embodiment, the plasticizer is a food-compliant plasticizer. By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA. In one embodiment or in combination with any other embodiment, the food-compliant plasticizer is triacetin or polyethylene glycol (PEG) having a molecular weight of about 200 to about 600. In embodiments, examples of food-compliant plasticizers that could be considered can include triacetin, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate.

In one embodiment or in combination with any other embodiment, the plasticizer can be present in an amount sufficient to permit the cellulose ester composition to be melt processed (or thermally formed) into useful articles, e.g., single use plastic articles, in conventional melt processing equipment. In one embodiment or in combination with any other embodiment, the plasticizer is present in an amount from 1 to 40 wt % for most thermoplastics processing; or 5 to 25 wt %, or 10 to 25 wt %, or 12 to 20 wt % based on the weight of the cellulose ester composition. In embodiments, profile extrusion, sheet extrusion, thermoforming, and injection molding can be accomplished with plasticizer levels in the 10-30, or 12-25, or 15-20, or 10-25 wt % range, based on the weight of the cellulose ester composition.

In one embodiment or in combination with any other embodiment, the plasticizer is a biodegradable plasticizer. Some examples of biodegradable plasticizers include triacetin, triethyl citrate, acetyl triethyl citrate, polyethylene glycol, the benzoate containing plasticizers such as the Benzoflex™ plasticizer series, poly(alkyl succinates) such as poly(butyl succinate), polyethersulfones, adipate based plasticizers, soybean oil epoxides such as the Paraplex™ plasticizer series, sucrose based plasticizers, dibutyl sebacate, tributyrin, the Resoflex™ series of plasticizers, triphenyl phosphate, glycolates, polyethylene glycol, 2,2,4-trimethylpentane-1,3-diyl bis(2-methylpropanoate), and polycaprolactones.

### PEG/MPEG Specific Compositions

In one embodiment or in combination with any other embodiment, the cellulose ester composition can contain a plasticizer selected from the group consisting of PEG and MPEG (methoxy PEG). The polyethylene glycol or a methoxy polyethylene glycol composition having an average molecular weight of from 200 Daltons to 600 Daltons, wherein the composition is melt processable, biodegradable, and disintegrable.

In one embodiment or in combination with any other embodiment, the composition comprises polyethylene glycol or methoxy PEG having an average molecular weight of from 300 to 550 Daltons.

In one embodiment or in combination with any other embodiment, the composition comprises polyethylene glycol having an average molecular weight of from 300 to 500 Daltons.

In one embodiment or in combination with any other embodiment, the cellulose ester composition comprises at least one plasticizer (as described herein) in an amount from 1 to 40 wt %, or 5 to 40 wt %, or 10 to 40 wt %, or 12 to 40 wt %, 13 to 40 wt %, or 15 to 40 wt %, or greater than 15 to 40 wt %, or 17 to 40 wt %, or 20 to 40 wt %, or 25 to 40 wt %, or 5 to 35 wt %, or 10 to 35 wt %, or 13 to 35 wt %, or 15 to 35 wt %, or greater than 15 to 35 wt %, or 17 to 35 wt %, or 20 to 35 wt %, or 5 to 30 wt %, or 10 to 30 wt %, or 13 to 30 wt %, or 15 to 30 wt %, or greater than 15 to 30 wt %, or 17 to 30 wt %, or 5 to 25 wt %, or 10 to 25 wt %, or 13 to 25 wt %, or 15 to 25 wt %, or greater than 15 to 25 wt %, or 17 to 25 wt %, or 5 to 20 wt %, or 10 to 20 wt %, or 13 to 20 wt %, or 15 to 20 wt %, or greater than 15 to 20 wt %, or 17 to 20 wt %, or 5 to 17 wt %, or 10 to 17 wt %, or 13 to 17 wt %, or 15 to 17 wt %, or greater than 15 to 17 wt %, or 5 to less than 17 wt %, or 10 to less than 17 wt %, or 13 to less than 17 wt %, or 15 to less than 17 wt %, all based on the total weight of the cellulose ester composition.

In one embodiment or in combination with any other embodiment, the at least one plasticizer includes or is a food-compliant plasticizer. In one embodiment or in combination with any other embodiment, the food-compliant plasticizer includes or is triacetin or PEG MW 300 to 500.

In one embodiment or in combination with any other embodiment, the cellulose ester composition comprises a biodegradable cellulose ester (BCE) component that comprises at least one BCE and a biodegradable polymer component that comprises at least one other biodegradable polymer (other than the BCE). In one embodiment or in combination with any other embodiment, the other biodegradable polymer can be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In one embodiment or in combination with any other embodiment, the cellulose ester composition comprises two or more biodegradable polymers. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the cellulose ester composition. In one embodiment or in combination with any other embodiment, the cellulose ester composition contains a biodegradable polymer (other than the BCE) in an amount from 0.1 to less than 50 wt %, or 1 to 40 wt %, or 1 to 30 wt %, or 1 to 25 wt %, or 1 to 20 wt %, based on the total amount of BCE and biodegradable polymer. In one embodiment or in combination with any other embodiment, the at least one biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In one embodiment or in combination with any other embodiment, the PHA can include a polyhydroxybutyrate-co-hydroxyhexanoate.

### Alkaline Filler

The alkaline filler suitable for the invention is at least one selected from the group consisting of metal oxides, metal hydroxides, metal carbonates and mixtures thereof. Blends of alkaline fillers can be used in the cellulose ester composition. In one embodiment or in combination with any other embodiment, the alkaline filler is at least one selected from the group consisting of alkaline-earth metal oxides, alkaline-earth metal hydroxides and alkaline-earth carbonates.

The alkaline fillers have specific physical properties. To be suitable in the application, the water-solubility of the alkaline filler at 20-25° C. is only useful within a certain range. If water solubility is too high, then moisture in the melt-processed article can pre-maturely initiate the chemistry of disintegration. If the water solubility is too low, then basic ions (OH⁻¹ or CO₃⁻²) cannot be released from the filler. Furthermore, the pH of a 1 wt % solution or suspension of the alkaline filler should be pH 8 or greater, which is related to water solubility. If the pH is not 8 or greater, the conditions are not suitable to promote the chemistry of disintegration. In one embodiment or in combination with any other embodiment, the pH of a 1 wt % solution or suspension of the alkaline filler is pH 8.5 or greater. In one embodiment or in combination with any other embodiment, the pH of a 1 wt % solution or suspension of the alkaline filler can range from about 8 to about 12, about 8 to about 11.5, about 8 to about 11, about 8 to about 10.5, about 8 to about 10; 8.5 to about 12, about 8.5 to about 11.5, about 8.5 to about 11, about 8.5 to about 10.5, about 8.5 to about 10, about 9 to about 12, about 9 to about 11.5, about 9 to about 11, and about 9 to about 10.5. Not all metal oxides, hydroxides & carbonates are suitable in the invention. For example, aluminum oxide (Al₂O₃) and titanium dioxide (TiO₂) are insoluble in water and do not react with water to form the corresponding hydroxide to change the pH of the water.

“Alkaline efficiency” is defined as the moles of base divided by the kilograms of alkaline filer. Alkaline efficiency of an alkaline filler also dictates its ability to promote disintegration via chemical action. Alkaline efficiency is the moles of basic ion associated with a specific mass of the filler, in the presence of water. For example, CaO and MgO react with water, and two moles of hydroxide ion (OH⁻¹) are formed. An alkaline filler with a higher alkaline efficiency may promote the chemistry underlying disintegration at lower filler loadings on a wt % basis in the formulation. A stoichiometric amount of an alkaline catalyst is required for the base-catalyzed hydrolysis of an ester, as the resulting acid formed will neutralize the base catalyst and deactivate it.

To be suitable in the application, the water-solubility of the alkaline filler at 20-25° C. should be greater than 1 ppm but less than 1,000 ppm. In other embodiments of the invention, the water-solubility of the alkaline filler at 20-25 C is between about 2 ppm to about 1,000 ppm, about 2 ppm to about 950 ppm, about 2 ppm to about 900 ppm, about 2 ppm to about 850 ppm, about 2 ppm to about 800 ppm, about 2 ppm to about 750 ppm, about 2 ppm to about 700 ppm, about 2 ppm to about 650 ppm, about 2 ppm to about 600 ppm, about 2 ppm to about 550 ppm, about 2 ppm to about 500 ppm, about 2 ppm to about 450 ppm, about 2 ppm to about 400 ppm, about 2 ppm to about 350 ppm, about 2 ppm to about 300 ppm, 3 ppm to about 1,000 ppm, about 3 ppm to about 950 ppm, about 3 ppm to about 900 ppm, about 3 ppm to about 850 ppm, about 3 ppm to about 800 ppm, about 3 ppm to about 750 ppm, about 3 ppm to about 700 ppm, about 3 ppm to about 650 ppm, about 3 ppm to about 600 ppm, about 3 ppm to about 550 ppm, about 3 ppm to about 500 ppm, about 3 ppm to about 450 ppm, about 3 ppm to about 400 ppm, about 3 ppm to about 350 ppm, about 3 ppm to about 300 ppm, 4 ppm to about 1,000 ppm, about 4 ppm to about 950 ppm, about 4 ppm to about 900 ppm, about 4 ppm to about 850 ppm, about 4 ppm to about 800 ppm, about 4 ppm to about 750 ppm, about 4 ppm to about 700 ppm, about 4 ppm to about 650 ppm, about 4 ppm to about 600 ppm, about 4 ppm to about 550 ppm, about 4 ppm to about 500 ppm, about 4 ppm to about 450 ppm, about 4 ppm to about 400 ppm, about 4 ppm to about 350 ppm, about 4 ppm to about 300 ppm, 5 ppm to about 1,000 ppm, about 5 ppm to about 950 ppm, about 5 ppm to about 900 ppm, about 5 ppm to about 850 ppm, about 5 ppm to about 800 ppm, about 5 ppm to about 750 ppm, about 5 ppm to about 700 ppm, about 5 ppm to about 650 ppm, about 5 ppm to about 600 ppm, about 5 ppm to about 550 ppm, about 5 ppm to about 500 ppm, about 5 ppm to about 450 ppm, about 5 ppm to about 400 ppm, about 5 ppm to about 350 ppm, about and 5 ppm to about 300 ppm.

In one embodiment or in combination with any other embodiment, the pH of a 1 wt % suspension of the alkaline filler should be 8 or greater, and the alkaline efficiency should be at least 5. In one embodiment or in combination with any other embodiment, the alkaline efficiency is at least 6, at least 7, at least 8, at least 9, or at least 10. The table below shows comparative properties of a selection of alkaline fillers, only some of which meet all the criteria for the invention. Examples of alkaline fillers that meet the criteria include calcium carbonate (CaCO₃), magnesium oxide (MgO), magnesium hydroxide (Mg(OH)₂), magnesium carbonate (MgCO₃), and barium carbonate (BaCO₃). Alkaline fillers that are effective and readily available are calcium carbonate (CaCO₃), magnesium oxide (MgO), magnesium hydroxide (Mg(OH)₂), and magnesium carbonate (MgCO₃). In addition, these alkaline fillers are especially suitable for food contact applications.

In one embodiment or in combination with any other embodiment, the alkaline filler is a mixture of calcium carbonate and at least one of the following of magnesium oxide, magnesium hydroxide, or magnesium carbonate, wherein the calcium carbonate is present at from 5 to 25 weight % and the at least one of the following of magnesium oxide, magnesium hydroxide, or magnesium carbonate is present at from 1 to 20 weight % based on the total weight of the cellulose ester composition. In one embodiment or in combination with any other embodiment, the alkaline filler is a mixture of calcium carbonate and at least one of the following of magnesium oxide, magnesium hydroxide, or magnesium carbonate, wherein the calcium carbonate is present at from 5 to 15 weight % and the at least one of the following of magnesium oxide, magnesium hydroxide, or magnesium carbonate is present at from 1 to 20 weight % based on the total weight of the cellulose ester composition. In one embodiment or in combination with any other embodiment, the alkaline filler is a mixture of calcium carbonate and at least one of the following of magnesium oxide, magnesium hydroxide, or magnesium carbonate, wherein the calcium carbonate is present at from 5 to 10 weight % and the at least one of the following of magnesium oxide, magnesium hydroxide, or magnesium carbonate is present at from 1 to 20 weight % based on the total weight of the cellulose ester composition.

The alkaline filler may be hydrated. A blend of alkaline fillers is also an option for creating alkaline conditions to promote disintegration. An alkaline filler, hydrate or blend may be a natural or synthetic blend, compound or mineral. For example, magnesium carbonate can be mined as the mineral magnesite or prepared in the laboratory by reacting a soluble magnesium salt with sodium bicarbonate. Examples of hydrates and blends as minerals include basic magnesium carbonate (BMC, typically hydrated with 3 to 5 water molecules), artinite (4MgCO₃·Mg(OH)₂·3H₂O), hydromagnesite (Mg₅(CO₃)₄ (OH)₂·4H₂O), dypingite (4MgCO₃·Mg(OH)₂·5H₂O) and dolomite (CaCO₃·MgCO₃). If a soluble magnesium salt (e.g. magnesium chloride or sulfate) is treated with sodium carbonate or sodium bicarbonate, depending on the reaction temperature and CO₂ partial pressure, the resulting precipitate may include a hydrated complex of magnesium carbonate and/or magnesium hydroxide, such as [MgCO₃·3H₂O] or [4MgCO₃·Mg(OH)₂·4H₂O]. A blend may also be made by combining MgO, Mg(OH)₂ and/or an anhydrous or hydrated form of MgCO₃ with each other, or with another mineral in the same water solubility range (e.g. CaCO₃ or BaCO₃).

TABLE 1

| | | Solubility | | Moles | Alkaline |
|---|---|---|---|---|---|
| | | in water | PH (1 | base/mole | efficiency:Moles |
| | Formula | (20-25° C.) | wt % in | filler (in | base/Kg |
| Filler | Weight | (mg/L = ppm) | water) | water) | filler |
| NaHCO₃ | 84.01 | >100,000 | 8.3 | 1 | 11.9 |
| Na₂CO₃ | 105.99 | >100,000 | 10.5 | 1 | 9.4 |
| CaO | 56.08 | 1,200 | 12.5 | 2 | 35.7 |
| Ca(OH)₂ | 74.09 | 1,600 | 12.8 | 2 | 27.0 |
| CaCO₃ | 100.09 | 15 | 8.4 | 1 | 10.0 |
| MgO | 40.31 | 12 | 9-10 | 2 | 49.6 |
| Mg(OH)₂ | 58.32 | 9 | 10 | 2 | 34.3 |
| MgCO₃ (anhydrous) | 84.31 | 100 | 10-11 | 1 | 11.9 |
| MgCO₃ · 3H₂O | 138.36 | 770 | 9-10 | 1 | 7.2 |
| 4MgCO₃ · Mg(OH)₂ · 4H₂O | 467.64 | 170 | 8 | 6 | 12.8 |
| BaO | 153.33 | 34,800 | 11 | 2 | 13.0 |
| Ba(OH)₂ | 171.34 | 38,900 | 11 | 2 | 11.7 |
| BaCO₃ | 197.34 | 24 | 9 | 1 | 5.1 |
| Al₂O₃ | 101.96 | <1 | 7 | 0 | 0 |
| ZnO | 81.41 | <1 | 7 | 0 | 0 |
| TiO₂ | 79.87 | <1 | 7.5 | 0 | 0 |

While it is not necessary, it is beneficial that the alkaline filler has the potential to undergo volumetric expansion. For example, the hydration of MgO to magnesium hydroxide (Mg(OH)₂) results in an increase in volume. During hydration, the weight of a mole of MgO increases from 40.3 g to 58.3 g (i.e., a 44.7% increase), and the filler volume can increase 2.2 times after complete hydration. Localized volume expansion creates tensile stress in the melt processed article and can lead to the formation of cracks and fissures that will contribute to disintegration. Similarly, MgCO₃ can hydrate, which changes the filler density and greatly increases the molar volume. MgCO₃ can also react with aqueous acids to release CO₂ and water, with concomitant volumetric expansion inside a thermoformed article leading to internal tensile stress, physical deformation and/or failure.

TABLE 2

| | Formula | | Molar |
|---|---|---|---|
| Alkaline | Weight | Density | volume |
| filler | (g/mole) | (g/cm³) | (cm³/mol) |
| MgO | 40.30 | 3.58 | 11.26 |
| Hydrated MgO, Mg(OH)₂ | 58.32 | 2.34 | 24.92 |
| MgCO₃ | 84.31 | 2.96 | 28.48 |
| MgCO₃, trihydrate | 138.36 | 1.84 | 75.20 |
| MgCO₃, pentahydrate | 174.39 | 1.73 | 100.80 |

To be useful in the invention, the amount of alkaline filler is restricted to a specific range in the formulation. The amount should be that which does not lead to premature decomposition of the formulation and yet high enough to promote the chemistry of disintegration. When the alkaline filler is present at greater than 35 wt %, the alkalinity or free alkali combined with the heat of processing can lead to premature decomposition of the formulation. When the alkaline filler is present at too low a loading, it can be ineffective at promoting the chemistry of disintegration. In one embodiment or in combination with any other embodiment, the alkaline filler is present at about 0.1 wt % to about 30 wt %, or about, about 0.1 wt % to about 25 wt %, or about 0.1 wt % to about 20 wt %, or about 0.1 wt % to about 15 wt %, or about 1 wt % to about 35 wt %, or about 1 wt % to about 30 wt %, or about 1 wt % to about 25 wt %, or about 1 wt % to about 20 wt %, or about 1 wt % to about 15 wt %, or about 1 wt % to about 10 wt %, or about 1 wt % to about 5 wt %, or about 5 wt % to about 35 wt %, or about 5 wt % to about 30 wt %, or about 5 wt % to about 25 wt %, or about 5 wt % to about 20 wt %, or about 5 wt % to about 15 wt %, or about 5 wt % to about 10 wt %, or about 10 wt % to about 35 wt %, or about 10 wt % to about 30 wt %, or about 10 wt % to about 25 wt %, or about 10 wt % to about 20 wt %, or about 10 wt % to about 15 wt %, or about 15 wt % to about 35 wt %, or about 15 wt % to about 30 wt %, or about 15 wt % to about 25 wt %, or about 15 wt % to about 20 wt %, or about 15 wt % to about 20 wt %, or about 20 wt % to about 35 wt %, or about 20 wt % to about 30 wt %, or about 20 wt % to about 25 wt %, or about 25 wt % to about 35 wt %, or about 25 wt % to about 30 wt %, or between about 0.1 wt % and about 10 wt % in the cellulose ester composition by weight, about 0.5 wt % to about 10 wt %, or about 1 wt % to about 10 wt %, or about 1.5 wt % and about 10 wt %, or about 2 wt % and about 10 wt %, or about 2.5 wt % and about 10 wt %, or about 3 wt % and about 10 wt %, or about 3.5 wt % and about 10 wt %, or about 4 wt % to about 10 wt %, or about 4.5 wt % to about 10 wt %, or about 5 wt % to about 10 wt %, or 0.1 wt % and about 9.5 wt % in the cellulose ester composition by weight, about 0.5 wt % to about 9.5 wt %, or about 1 wt % to about 9.5 wt %, or about 1.5 wt % and about 9.5 wt %, or about 2 wt % and about 9.5 wt %, or about 2.5 wt % and about 9.5 wt %, or about 3 wt % and about 9.5 wt %, or about 3.5 wt % and about 9.5 wt %, or about 4 wt % and about 9.5 wt %, or about 4.5 wt % and about 9.5 wt %, or about 5 wt % and about 9.5 wt %, or 0.1 wt % and about 9 wt % in the cellulose ester composition by weight, or about 0.5 wt % to about 9 wt %, or about 1 wt % to about 9 wt %, or about 1.5 wt % and about 9 wt %, or about 2 wt % and about 9 wt %, or about 2.5 wt % and about 9 wt %, or about 3 wt % and about 9 wt %, or about 3.5 wt % and about 9 wt %, or about 4 wt % and about 9 wt %, or about 4.5 wt % and about 9 wt %, or about 5 wt % and about 9 wt %; or 0.1 wt % and about 8.5 wt % in the cellulose ester composition by weight, or about 0.5 wt % to about 8.5 wt %, or about 1 wt % to about 8.5 wt %, or about 1.5 wt % and about 8.5 wt %, or about 2 wt % and about 8.5 wt %, or about 2.5 wt % and about 8.5 wt %, or about 3 wt % and about 8.5 wt %, or about 3.5 wt % and about 8.5 wt %, or about 4 wt % and about 8.5 wt %, or about 4.5 wt % and about 8.5 wt %, or about 5 wt % and about 8.5 wt %; or 0.1 wt % and about 8 wt % in the cellulose ester composition by weight, about 0.5 wt % to about 8 wt %, or about 1 wt % to about 8 wt %, or about 1.5 wt % to about 8 wt %, or about 2 wt % to about 8 wt %, or about 2.5% to about 8%, or about 3% to about 8%, or about 3.5% to about 8 wt %, or about 4 wt % to about 8%, or about 4.5% to about 8%, or about 5% to about 8% by weight based on the cellulose ester composition.

### Neutralizing Agent

The melt processable cellulose ester composition also contains at least one neutralizing agent. To manage alkalinity or free alkali as a source of color, a neutralizing agent is also required in the formulation. The neutralizing agent is a carboxylic acid with a first pKa in the range of about 2 to about 7 or about 2 to about 6. Examples of neutralizing agents include, but are not limited to, citric acid, malic acid, succinic acid, adipic acid, fumaric acid, formic acid, lactic acid, maleic acid, tartaric acid, malonic acid, glutamic acid, glutaric acid, gluconic acid, isophthalic acid, terephthalic acid, glycolic acid, itaconic acid, ferulic acid, mandelic acid, aconitic acid, benzoic acid, aspartic acid, and vanillic acid.

In one embodiment or in combination with any other embodiment, the neutralizing agents are selected from the group consisting of citric acid, malic acid, succinic acid, adipic acid, and fumaric acid, especially for the use of cellulose ester compositions in food contact applications. In one embodiment or in combination with any other embodiment, the neutralizing agents are selected from the group consisting of citric acid, adipic acid, or fumaric acid.

The minimum amount of the neutralizing agent is that which is sufficient to neutralize the free alkali in the cellulose ester composition. However, an excess amount can be added. In one embodiment or in combination with any other embodiment, about 0.5 wt % to about 5 wt % of the neutralizing agent is added based on the weight of the cellulose ester composition. In one embodiment or in combination with any other embodiment, the neutralizing agent is present at from about 0.5 wt % to about 5 wt %, or about 0.5 wt % to about 4.5 wt %, or about 0.5 wt % to about 4 wt %, or about 0.5 wt % to about 3.5 wt %, or about 0.5 wt % to about 3 wt %, or about 0.5 wt % to about 2.5 wt %, or about 0.5 wt % to about 2 wt %, or about 0.5 wt % to about 1 wt %, or about 1.5 wt % to about 5 wt %, or about 1.5 wt % to about 4.5 wt %, or 1 wt % to about 5 wt %, or about 1 wt % to about 4.5 wt %, or about 1 wt % to about 4 wt %, or about 1 wt % to about 3.5 wt %, or about 1 wt % to about 3 wt %, or about 1 wt % to about 2.5 wt %, or about 1.5 wt % to about 5 wt %, or about 1.5 wt % to about 4.5 wt %, or about 1.5 wt % to about 4 wt %, or about 1.5 wt % to about 3.5 wt %, or about 1.5 wt % to about 3 wt %, or about 1.5 wt % to about 2.5 wt %, or about 2 wt % to about 5 wt %, or about 2 wt % to about 4.5 wt %, or about 2 wt % to about 4 wt %, or about 2 wt % to about 3.5 wt %, or about 2 wt % to about 3 wt % of the neutralizing agent is added based on the weight of the cellulose ester composition

### Appearance

The appearance of an article comprising the melt processable cellulose ester composition is important to its acceptability in many applications. For example, a light color and transparency are desired properties for many melt-processed articles like packaging, bags, films, bottles, food containers, straws, stirrers, cups, plates, bowls, take out trays and lids and cutlery.

In CIE L*a*b* color space, the L* value is a measure of brightness, with L*=0 being black and L*=100 being white. Therefore, the color of an article can be considered light if the L* value is in the upper half of that range, or L*>50. In one embodiment or in combination with any other embodiment, the L* of the cellulose ester composition can range from 50 to 100, 50 to 95, 50 to 90, 50 to 85, 50 to 80, 50 to 75, 55 to 100, 55 to 95, 55 to 90, 55 to 85, 55 to 80, 55 to 75, 60 to 100, 60 to 95, 60 to 90, 60 to 85, 60 to 80, 60 to 75, 65 to 100, 65 to 95, 65 to 90, 65 to 85, 65 to 80, or 65 to 75.

Opacity is the measure of light transmission through a film or article. Transparency refers to the optical distinctness with which an object can be seen when viewed through a film or sheet. The perceived opacity and transparency depend on the thickness of the sample. For the application examples above, article thickness can range from about 1 mil for packaging films up to 60 mil or greater for injection molded cutlery. Transparency may be especially important for viewing the contents of containers, such as through the side of a bottle or through a container lid. Melt-processed containers, cups and lids vary in thickness from about 10 mil to about 30 mil, while bottles are about 20 mil thick.

The boundaries between transparent, translucent and opaque are often highly subjective. In this study, opacity was measured as the % transmittance of light at 600 nm through a film 30 mil thick. In one embodiment or in combination with any other embodiment, the % transmittance of the inventive cellulose ester composition can range from about 1% to about 100%, about 1% to about 90%, about 1% to about 80%, about 1% to about 70%, about 1% to about 60%, about 1% to about 50%, about 1% to about 40%, about 1% to about 30%, about 1% to about 20%, about 1% to about 10%, and about 1%.

Transparency was quantified as color difference, Delta E (CIE76). On a typical scale, the Delta E value will range from 0 to 100. The ability of the human eye to distinguish between two colors is related to Delta E; colors with a Delta E<1 are not perceptible as different. On the other hand, colors with a Delta E>10 are perceived as different at a glance. We used a Delta E cutoff of 20 to designate a readily perceived distinction between black and white as observed through a 30 mil extruded film. The formula for Delta E (CIE76):

$$Δ {E}_{ab}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}}$$

In one embodiment or in combination with any other embodiment, the Delta E of the cellulose ester composition can range from about 20 to about 100.

### Other Elements of the Composition

In one embodiment or in combination with any other embodiment, the melt processable cellulose ester composition can further comprise at least one selected from the group consisting of a non-alkaline filler, additive, biopolymer, stabilizer, and/or odor modifier. Examples of additives include waxes, compatibilizers, biodegradation promoters, dyes, pigments, colorants, fragrances, luster control agents, lubricants, anti-oxidants, viscosity modifiers, antifungal agents, anti-fogging agents, flame retardants, heat stabilizers, impact modifiers, antibacterial agents, softening agents, mold release agents, and combinations thereof. It should be noted that the same type of compounds or materials can be identified for or included in multiple categories of components in the cellulose ester compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In one embodiment or in combination with any other embodiment, the cellulose ester composition comprises at least one stabilizer. Although it is desirable for the cellulose ester composition to be composable and/or biodegradable, a certain amount of stabilizer may be added to provide a selected shelf life or stability, e.g., towards light exposure, oxidative stability, or hydrolytic stability. In various embodiments, stabilizers can include: UV absorbers, antioxidants (ascorbic acid, BHT, BHA, etc.), other acid and radical scavengers, epoxidized oils, e.g., epoxidized soybean oil, or combinations thereof.

Antioxidants can be classified into several classes, including primary antioxidant, and secondary antioxidant. Primary antioxidants are generally known to function essentially as free radical terminators (scavengers). Secondary antioxidants are generally known to decompose hydroperoxides (ROOH) into nonreactive products before they decompose into alkoxy and hydroxy radicals. Secondary antioxidants are often used in combination with free radical scavengers (primary antioxidants) to achieve a synergistic inhibition effect and secondary AOs are used to extend the life of phenolic type primary AOs.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include BHT, Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120, 2246, and 565; Anox™ 20, 29, 330, 70, IC-14, and 1315; Lowinox™ 520, 1790, 22IB46, 22M46, 44B25, AH25, GP45, CA22, CPL, HD98, TBM-6, and WSP; Naugard™ 431, PS48, SP, and 445; Songnox™ 1010, 1024, 1035, 1076 CP, 1135 LQ, 1290 PW, 1330FF, 1330 PW, 2590 PW, and 3114 FF; and ADK Stab AO-20, AO-30, AO-40, AO-50, AO-60, AO-80, and AO-330.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, S-9228, S-9228T; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

In one embodiment or in combination with any other embodiment, the cellulose ester composition comprises at least one stabilizer, wherein the stabilizer comprises one or more secondary antioxidants. In one embodiment or in combination with any other embodiment, the stabilizer comprises a first stabilizer component chosen from one or more secondary antioxidants and a second stabilizer component chosen from one or more primary antioxidants, or a combination thereof.

In one embodiment or in combination with any other embodiment, the stabilizer comprises one or more secondary antioxidants in an amount in the range of from 0.01 to 0.8, or 0.01 to 0.7, or 0.01 to 0.5, or 0.01 to 0.4, or 0.01 to 0.3, or 0.01 to 0.25, or 0.01 to 0.2, or 0.05 to 0.8, or 0.05 to 0.7, or 0.05 to 0.5, or 0.05 to 0.4, or 0.05 to 0.3, or 0.05 to 0.25, or 0.05 to 0.2, or 0.08 to 0.8, or 0.08 to 0.7, or 0.08 to 0.5, or 0.08 to 0.4, or 0.08 to 0.3, or 0.08 to 0.25, or 0.08 to 0.2, in weight percent of the total amount of secondary antioxidants based on the total weight of the composition. In one class of this embodiment, the stabilizer comprises a secondary antioxidant that is a phosphite compound. In one class of this embodiment, the stabilizer comprises a secondary antioxidant that is a phosphite compound and another secondary antioxidant that is DLTDP.

In one subclass of this class, the stabilizer further comprises a second stabilizer component that comprises one or more primary antioxidants in an amount in the range of from 0.05 to 0.7, or 0.05 to 0.6, or 0.05 to 0.5, or 0.05 to 0.4, or 0.05 to 0.3, or 0.1 to 0.6, or 0.1 to 0.5, or 0.1 to 0.4, or 0.1 to 0.3, in weight percent of the total amount of primary antioxidants based on the total weight of the composition. In another subclass of this class, the stabilizer further comprises a second stabilizer component that comprises citric acid in an amount in the range of from 0.05 to 0.2, or 0.05 to 0.15, or 0.05 to 0.1 in weight percent of the total amount of citric acid based on the total weight of the composition. In another subclass of this class, the stabilizer further comprises a second stabilizer component that comprises one or more primary antioxidants and citric acid in the amounts discussed herein. In one subclass of this class, the stabilizer comprises less than 0.1 wt % or no primary antioxidants, based on the total weight of the composition. In one subclass of this class, the stabilizer comprises less than 0.05 wt % or no primary antioxidants, based on the total weight of the composition.

In one embodiment or in combination with any other embodiment, the cellulose ester composition comprises at least one non-alkaline filler. In one embodiment or in combination with any other embodiment, the other filler is at least one selected from the group consisting of carbohydrates (sugars and salts), cellulosic and organic fillers (ground nut shells, cork powder, grain by-products [e.g., rice hulls, oat bran] wood flour, wood fibers, hemp, carbon, coal particles, graphite, and starches), mineral and inorganic fillers (talc, silica, silicates, titanium dioxide, glass fibers, glass spheres, boronitride, aluminum trihydrate, alumina, and clays), food wastes or byproduct (eggshells, distillers grain, and coffee grounds), desiccants (e.g. calcium sulfate, magnesium sulfate), alkaline fillers outside definition in claims (e.g., CaO, Na₂CO₃), or combinations (e.g., mixtures) of these fillers. In one embodiment or in combination with any other embodiment, the cellulose ester compositions can include at least one filler that also functions as a colorant additive. In one embodiment or in combination with any other embodiment, the colorant additive filler can be chosen from: carbon, graphite, titanium dioxide, opacifiers, dyes, pigments, toners and combinations thereof. In one embodiment or in combination with any other embodiment, the cellulose ester compositions can include at least one filler that also functions as a stabilizer or flame retardant.

In one embodiment or in combination with any other embodiment, the cellulose ester composition further comprises at least one non-alkaline filler (as described herein) in an amount from 1 to 60 wt %, or 5 to 55 wt %, or 5 to 50 wt %, or 5 to 45 wt %, or 5 to 40 wt %, or 5 to 35 wt %, or 5 to 30 wt %, or 5 to 25 wt %, or 10 to 55 wt %, or 10 to 50 wt %, or 10 to 45 wt %, or 10 to 40 wt %, or 10 to 35 wt %, or 10 to 30 wt %, or 10 to 25 wt %, or 15 to 55 wt %, or 15 to 50 wt %, or 15 to 45 wt %, or 15 to 40 wt %, or 15 to 35 wt %, or 15 to 30 wt %, or 15 to 25 wt %, or 20 to 55 wt %, or 20 to 50 wt %, or 20 to 45 wt %, or 20 to 40 wt %, or 20 to 35 wt %, or 20 to 30 wt %, all based on the total weight of the cellulose ester composition.

In one embodiment or in combination with any other embodiment, depending on the application, e.g., single use food contact applications, the cellulose ester composition can include at least one odor modifying additive. In one embodiment or in combination with any other embodiment, depending on the application and components used in the cellulose ester composition, suitable odor modifying additives can be chosen from: vanillin, Pennyroyal M-1178, almond, cinnamyl, spices, spice extracts, volatile organic compounds or small molecules, and Plastidor. In one embodiment or in combination with any other embodiment, the odor modifying additive can be vanillin. In one embodiment or in combination with any other embodiment, the cellulose ester composition can include an odor modifying additive in an amount from 0.01 to 1 wt %, or 0.1 to 0.5 wt %, or 0.1 to 0.25 wt %, or 0.1 to 0.2 wt %, based on the total weight of the composition. Mechanisms for the odor modifying additives can include masking, capturing, complementing or combinations of these.

As discussed above, the cellulose ester composition can include other additives. In one embodiment or in combination with any other embodiment, the cellulose ester composition can include at least one compatibilizer. In one embodiment or in combination with any other embodiment, the compatibilizer can be either a non-reactive compatibilizer or a reactive compatibilizer. The compatibilizer can enhance the ability of the cellulose ester or another component to reach a desired small particle size to improve the dispersion of the chosen component in the composition. In such embodiments, depending on the desired formulation, the biodegradable cellulose ester can either be in the continuous or discontinuous phase of the dispersion. In one embodiment or in combination with any other embodiment, the compatibilizers used can improve mechanical and/or physical properties of the compositions by modifying the interfacial interaction/bonding between the biodegradable cellulose ester and another component, e.g., other biodegradable polymer.

In one embodiment or in combination with any other embodiment, the cellulose ester composition comprises a compatibilizer in an amount from about 1 to about 40 wt %, or about 1 to about 30 wt %, or about 1 to about 20 wt %, or about 1 to about 10 wt %, or about 5 to about 20 wt %, or about 5 to about 10 wt %, or about 10 to about 30 wt %, or about 10 to about 20 wt %, based on the weight of the cellulose ester composition.

In one embodiment or in combination with any other embodiment, if desired, the cellulose ester composition can include biodegradation and/or decomposition agents, e.g., hydrolysis assistant or any intentional degradation promoter additives can be added to or contained in the cellulose ester composition, added either during manufacture of the biodegradable cellulose ester (BCE) or subsequent to its manufacture and melt or solvent blended together with the BCE to make the cellulose ester composition. In one embodiment or in combination with any other embodiment, additives can promote hydrolysis by releasing acidic or basic residues, and/or accelerate photo (UV) or oxidative degradation and/or promote the growth of selective microbial colony to aid the disintegration and biodegradation in compost and soil medium. In addition to promoting degradation, these additives can have an additional function such as improving the processability of the article or improving desired mechanical properties.

One set of examples of possible decomposition agents include inorganic carbonate, synthetic carbonate, nepheline syenite, talc, aluminum hydroxide, diatomaceous earth, natural or synthetic silica, calcined clay, and the like. In embodiments, it may be desirable that these additives are dispersed well in the cellulose ester composition matrix. The additives can be used singly, or in a combination of two or more.

Another set of examples of possible decomposition agents are aromatic ketones used as an oxidative decomposition agent, including benzophenone, anthraquinone, anthrone, acetylbenzophenone, 4-octylbenzophenone, and the like. These aromatic ketones may be used singly, or in a combination of two or more.

Other examples include transition metal compounds used as oxidative decomposition agents, such as salts of cobalt or magnesium, e.g., aliphatic carboxylic acid (C12 to C20) salts of cobalt or magnesium, or cobalt stearate, cobalt oleate, magnesium stearate, and magnesium oleate; or anatase-form titanium dioxide, or titanium dioxide may be used. Mixed phase titanium dioxide particles may be used in which both rutile and anatase crystalline structures are present in the same particle. The particles of photoactive agent can have a relatively high surface area, for example from about 10 to about 300 sq. m/g, or from 20 to 200 sq. m/g, as measured by the BET surface area method. The photoactive agent can be added to the plasticizer if desired. These transition metal compounds can be used singly, or in a combination of two or more.

Examples of rare earth compounds that can used as oxidative decomposition agents include rare earths belonging to periodic table Group 3A, and oxides thereof. Specific examples thereof include cerium (Ce), yttrium (Y), neodymium (Nd), rare earth oxides, hydroxides, rare earth sulfates, rare earth nitrates, rare earth acetates, rare earth chlorides, rare earth carboxylates, and the like. More specific examples thereof include cerium oxide, ceric sulfate, ceric ammonium Sulfate, ceric ammonium nitrate, cerium acetate, lanthanum nitrate, cerium chloride, cerium nitrate, cerium hydroxide, cerium octylate, lanthanum oxide, yttrium oxide, Scandium oxide, and the like. These rare earth compounds may be used singly, or in a combination of two or more.

In one embodiment or in combination with any other embodiment, the melt processable cellulose ester composition includes an additive with pro-degradant functionality to enhance biodegradability that comprises an enzyme, a bacterial culture, a sugar, glycerol or other energy sources. The additive can also comprise hydroxylamine esters and thio compounds.

In certain embodiments, other possible biodegradation and/or decomposition agents can include swelling agents and disintegrants. Swelling agents can be hydrophilic materials that increase in volume after absorbing water and exert pressure on the surrounding matrix. Disintegrants can be additives that promote the breakup of a matrix into smaller fragments in an aqueous environment. Examples include minerals and polymers, including crosslinked or modified polymers and swellable hydrogels. In embodiments, the BCE composition may include water-swellable minerals or clays and their salts, such as laponite and bentonite; hydrophilic polymers, such as poly(acrylic acid) and salts, poly(acrylamide), poly(ethylene glycol) and poly(vinyl alcohol); polysaccharides and gums, such as starch, alginate, pectin, chitosan, psyllium, xanthan gum; guar gum, locust bean gum; and modified polymers, such as crosslinked PVP, sodium starch glycolate, carboxymethyl cellulose, gelatinized starch, croscarmellose sodium; or combinations of these additives.

Examples of other hydrophilic polymers or biodegradation promoters may include glycols, polyglycols, polyethers, and polyalcohols or other biodegradable polymers such as poly(glycolic acid), poly(lactic acid), polyethylene glycol, polypropylene glycol, polydioxanes, polyoxalates, poly(α-esters), polycarbonates, polyanhydrides, polyacetals, polycaprolactones, poly(orthoesters), polyamino acids, poly(hydroxyalkanoates), aliphatic polyesters such as poly(butylene) succinate, poly(ethylene) succinate, starch, regenerated cellulose, or aliphatic-aromatic polyesters such as PBAT, and co-polyesters of any of these.

In one embodiment or in combination with any other embodiment, examples of colorants can include carbon black, iron oxides such as red or blue iron oxides, titanium dioxide, silicon dioxide, cadmium red, calcium carbonate, kaolin clay, aluminum hydroxide, barium sulfate, zinc oxide, aluminum oxide; and organic pigments such as azo and diazo and triazo pigments, condensed azo, azo lakes, naphthol pigments, anthrapyrimidine, benzimidazolone, carbazole, diketopyrrolopyrrole, flavanthrone, indigoid pigments, isoindolinone, isoindoline, isoviolanthrone, metal complex pigments, oxazine, perylene, perinone, pyranthrone, pyrazoloquinazolone, quinophthalone, triarylcarbonium pigments, triphendioxazine, xanthene, thioindigo, indanthrone, isoindanthrone, anthanthrone, anthraquinone, isodibenzanthrone, triphendioxazine, quinacridone and phthalocyanine series, especially copper phthalocyanme and its nuclear halogenated derivatives, and also lakes of acid, basic and mordant dyes, and isoindolinone pigments, as well as plant and vegetable dyes, and any other available colorant or dye.

In one embodiment or in combination with any other embodiment, luster control agents for adjusting the glossiness and fillers can include silica, talc, clay, barium sulfate, barium carbonate, calcium sulfate, calcium carbonate, magnesium carbonate, and the like.

Suitable flame retardants can include silica, metal oxides, phosphates, catechol phosphates, resorcinol phosphates, borates, inorganic hydrates, and aromatic polyhalides.

Antifungal and/or antibacterial agents include polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Viscosity modifiers having the purpose of modifying the melt flow index or viscosity of the biodegradable cellulose ester composition that can be used include polyethylene glycols and polypropylene glycols, and glycerin.

In one embodiment or in combination with any other embodiment, other components that can be included in the melt processable cellulose ester composition may function as release agents or lubricants (e.g. fatty acids, ethylene glycol distearate), anti-block or slip agents (e.g. fatty acid esters, metal stearate salts (for example, zinc stearate), and waxes), antifogging agents (e.g. surfactants), thermal stabilizers (e.g. epoxy stabilizers, derivatives of epoxidized soybean oil (ESBO), linseed oil, and sunflower oil), anti-static agents, foaming agents, biocides, impact modifiers, or reinforcing fibers. More than one component may be present in the BCE composition. It should be noted that an additional component may serve more than one function in the metl processable cellulos ester composition. The different (or specific) functionality of any particular additive (or component) to the melt processable cellulose ester composition can be dependent on its physical properties (e.g., molecular weight, solubility, melt temperature, Tg, etc.) and/or the amount of such additive/component in the overall composition. For example, polyethylene glycol can function as a plasticizer at one molecular weight or as a hydrophilic agent (with little or no plasticizing effect) at another molecular weight.

In embodiments, fragrances can be added if desired. Examples of fragrances can include spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vanillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In one embodiment or in combination with any other embodiment, the cellulose ester composition and any article made from or comprising such composition comprises biodegradable cellulose ester (BCE) that contains some recycle content. In embodiments, the recycle content is provided by a reactant derived from recycled material that is the source of one or more acetyl groups on the BCE. In embodiments, the reactant is derived from recycled plastic. In embodiments, the reactant is derived from recycled plastic content syngas. By “recycled plastic content syngas” is meant syngas obtained from a synthesis gas operation utilizing a feedstock that contains at least some content of recycled plastics, as described in the various embodiments more fully herein below. In embodiments, the recycled plastic content syngas can be made in accordance with any of the processes for producing syngas described herein; can comprise, or consist of, any of the syngas compositions or syngas composition streams described herein; or can be made from any of the feedstock compositions described herein.

In one embodiment or in combination with any other embodiment, the feedstock (for the synthesis gas operation) can be in the form of a combination of one or more particulated fossil fuel sources and particulated recycled plastics. In one embodiment or in any of the mentioned embodiments, the solid fossil fuel source can include coal. In one embodiment or in combination with any other embodiment, the feedstock is fed to a gasifier along with an oxidizer gas, and the feedstock is converted to syngas.

In one embodiment or in combination with any other embodiment, the recycled plastic content syngas is utilized to make at least one chemical intermediate in a reaction scheme to make a Recycle cellulos ester. In one embodiment or in combination with any other embodiment, the recycled plastic content syngas can be a component of feedstock (used to make at least one CA intermediate) that includes other sources of syngas, hydrogen, carbon monoxide, or combinations thereof. In one embodiment or in any of the mentioned embodiments, the only source of syngas used to make the CA intermediates is the recycled plastic content syngas.

In one embodiment or in combination with any other embodiment, the CA intermediates made using the recycled content syngas, e.g., recycled plastic content syngas, can be chosen from methanol, acetic acid, methyl acetate, acetic anhydride and combinations thereof. In one embodiment or in combination with any other embodiment, the CA intermediates can be a at least one reactant or at least one product in one or more of the following reactions: (1) syngas conversion to methanol; (2) syngas conversion to acetic acid; (3) methanol conversion to acetic acid, e.g., carbonylation of methanol to produce acetic acid; (4) producing methyl acetate from methanol and acetic acid; and (5) conversion of methyl acetate to acetic anhydride, e.g., carbonylation of methyl acetate and methanol to acetic acid and acetic anhydride.

In one embodiment or in combination with any other embodiment, recycled plastic content syngas is used to produce at least one cellulose reactant. In embodiments, the recycled plastic content syngas is used to produce at least one Recycle cellulose ester.

In one embodiment or in combination with any other embodiment, the recycled plastic content syngas is utilized to make acetic anhydride. In one embodiment or in combination with any other embodiment, syngas that comprises recycled plastic content syngas is first converted to methanol and this methanol is then used in a reaction scheme to make acetic anhydride. “RPS acetic anhydride” refers to acetic anhydride that is derived from recycled plastic content syngas. Derived from means that at least some of the feedstock source material (that is used in any reaction scheme to make a CA intermediate) has some content of recycled plastic content syngas.

In one embodiment or in combination with any other embodiment, the RPS acetic anhydride is utilized as a CA intermediate reactant for the esterification of cellulose to prepare a Recycle BCE, as discussed more fully above. In one embodiment or in combination with any other embodiment, the RPS acetic acid is utilized as a reactant to prepare cellulose ester or cellulose diacetate.

In one embodiment or in combination with any other embodiment, the Recycle CA is prepared from a cellulose reactant that comprises acetic anhydride that is derived from recycled plastic content syngas.

In one embodiment or in combination with any other embodiment, the recycled plastic content syngas comprises gasification products from a gasification feedstock. In one embodiment or in combination with any other embodiment, the gasification products are produced by a gasification process using a gasification feedstock that comprises recycled plastics. In embodiments, the gasification feedstock comprises coal.

In embodiments, the gasification feedstock comprises a liquid slurry that comprises coal and recycled plastics. In embodiments, the gasification process comprises gasifying the gasification feedstock in the presence of oxygen.

In one embodiment or in combination with any other embodiment, a Recycle cellulose ester composition is provided that comprises at least one biodegradable cellulose ester having at least one substituent on an anhydroglucose unit (AGU) derived from one or more chemical intermediates, at least one of which is obtained at least in part from recycled plastic content syngas.

In one embodiment or in combination with any other embodiment, the Recycle cellulose ester is biodegradable and contains content derived from a renewable source, e.g., cellulose from wood or cotton linter, and content derived from a recycled material source, e.g., recycled plastics. Thus, in embodiments, a melt processible material is provided that is biodegradable and contains both renewable and recycled content, i.e., made from renewable and recycled sources.

In one embodiment or in combination with any other embodiment, a Cellulose ester composition is provided that comprises Recycle cellulose ester prepared by an integrated process which comprises the processing steps of: (1) preparing a recycled plastic content syngas in a synthesis gas operation utilizing a feedstock that contains a solid fossil fuel source and at least some content of recycled plastics; (2) preparing at least one chemical intermediate from the syngas; (3) reacting the chemical intermediate in a reaction scheme to prepare at least one cellulose reactant for preparing a Recycle cellulose ester, and/or selecting the chemical intermediate to be at least one cellulose reactant for preparing a Recycle cellulose ester; and (4) reacting the at least one cellulose reactant to prepare the Recycle cellulose ester; wherein the Recycle cellulose ester comprises at least one substituent on an anhydroglucose unit (AGU) derived from recycled plastic content syngas.

In one embodiment or in combination with any other embodiment, the processing steps (1) to (4) are carried out in a system that is in fluid and/or gaseous communication (i.e., including the possibility of a combination of fluid and gaseous communication). It should be understood that the chemical intermediates, in one or more of the reaction schemes for producing Recycle cellulose esters starting from recycled plastic content syngas, may be temporarily stored in storage vessels and later reintroduced to the integrated process system.

In one embodiment or in combination with any other embodiment, the at least one chemical intermediate is chosen from methanol, methyl acetate, acetic anhydride, acetic acid, or combinations thereof. In embodiments, one chemical intermediate is methanol, and the methanol is used in a reaction scheme to make a second chemical intermediate that is acetic anhydride. In embodiments, the cellulose reactant is acetic anhydride.

The biodegradable cellulose ester useful in embodiments of the present invention can have a degree of substitution in the range of from 1.0 to 2.5. In some cases, the cellulose ester as described herein may have an average degree of substitution of at least about 1.0, 1.05, 1.1, 1.15, 1.2, 1.25, 1.3, 1.35, 1.4, 1.45 or 1.5 and/or not more than about 2.5, 2.45, 2.4, 2.35, 2.3, 2.25, 2.2, 2.15, 2.1, 2.05, 2.0, 1.95, 1.9, 1.85, 1.8 or 1.75.

In one embodiment or in combination with any other embodiment, the biodegradable cellulose ester may have a number average molecular weight (Mn) of not more than 100,000, or not more than 90,000, measured using gel permeation chromatography with a polystyrene equivalent and using N-methyl-2-pyrrolidone (NMP) as the solvent. In some cases, the biodegradable cellulose ester may have a Mn of at least about 10,000, at least about 20,000, 25,000, 30,000, 35,000, 40,000, or 45,000 and/or not more than about 100,000, 95,000, 90,000, 85,000, 80,000, 75,000, 70,000, 65,000, 60,000, or 50,000.

### Biodegradation and Disintegration

In embodiments, the cellulose ester containing article can be biodegradable and have a certain degree of disintegration. Biodegradation refers to mineralization of a substance, or conversion to biomass, CO₂ and water by the action of microbial metabolism. In contrast, disintegration refers to the visible breakdown of a material, often through the combined action of physical, chemical and biological mechanisms.

In one embodiment or in combination with any other embodiment, the melt processable cellulose ester compositions show improved disintegration compared with formulations without the alkaline filler. The improvement may be measured as disintegration of thicker parts in the same amount of time, or it may refer to faster rate of disintegration. The degree of disintegration can be characterized by the weight loss of a sample over a given period of exposure to certain environmental conditions. In some cases, the melt processable cellulose ester composition can exhibit a weight loss of at least about 5, 10, 15, or 20 percent after burial in soil for 60 days and/or a weight loss of at least about 15, 20, 25, 30, or 35 percent after 15 days of exposure to a typical municipal composter. However, the rate of degradation may vary depending on the particular end use of the article, as well as the composition of the article, and the specific test. Exemplary test conditions are provided in U.S. Pat. Nos. 5,970,988 and 6,571,802.

In some embodiments, the melt processable cellulose ester composition may be in the form of biodegradable single use (formed/molded) articles. It has been found that melt processable cellulose ester compositions as described herein can exhibit enhanced levels of environmental non-persistence, characterized by better-than-expected degradation under various environmental conditions. cellulose ester containing articles described herein may meet or exceed passing standards set by international test methods and authorities for industrial compostability, home compostability, and/or soil biodegradability.

Disintegration refers to the physical breakdown of a material. Disintegration of a material may be influenced by biological, chemical and/or physical processes. Methods to monitor disintegration during composting may be performed in synthetic compost under standardized lab conditions, or as a field test in an authentic industrial or home compost system. Standardized methods to monitor disintegration in industrial compost are defined in ISO-20200 and ISO-16929. Qualitative screening tests may also be based on these standardized tests.

Home composting can be simulated under lab conditions, for example, by running ISO-16929 or ISO-20200 at lower temperatures, or by monitoring the disintegration of test materials in a home composting vessel. Home composting may also be conducted under conditions similar to those described in the standardized methods but conducted at larger scale in outdoor domestic composting bins.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) or ISO20200 must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth. As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

The cellulose ester composition (or article comprising same) can exhibit a biodegradation of at least 70 percent in a period of not more than 50 days, when tested under aerobic composting conditions at ambient temperature (28° C.±2° C.) according to ISO 14855-1 (2012). In some cases, the cellulose ester composition (or article comprising same) can exhibit a biodegradation of at least 70 percent in a period of not more than 49, 48, 47, 46, 45, 44, 43, 42, 41, 40, 39, 38, or 37 days when tested under these conditions, also called “home composting conditions.” These conditions may not be aqueous or anaerobic. In some cases, the cellulose ester composition (or article comprising same) can exhibit a total biodegradation of at least about 71, 72, 73, 74, 75, 76, 77, 78, 79, 80, 81, 82, 83, 84, 85, 86, 87, or 88 percent, when tested under according to ISO 14855-1 (2012) for a period of 50 days under home composting conditions. This may represent a relative biodegradation of at least about 95, 97, 99, 100, 101, 102, or 103 percent, when compared to cellulose subjected to identical test conditions.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year. The cellulose ester composition as described herein may exhibit a biodegradation of at least 90 percent within not more than 1 year, measured according 14855-1 (2012) under home composting conditions. In some cases, the cellulose ester composition (or article comprising same) may exhibit a biodegradation of at least about 91, 92, 93, 94, 95, 96, 97, 98, 99, or 99.5 percent within not more than 1 year, or cellulose ester composition (or article comprising same) may exhibit 100 percent biodegradation within not more than 1 year, measured according 14855-1 (2012) under home composting conditions.

Additionally, or in the alternative, the cellulose ester composition (or article comprising same) described herein may exhibit a biodegradation of at least 90 percent within not more than about 350, 325, 300, 275, 250, 225, 220, 210, 200, 190, 180, 170, 160, 150, 140, 130, 120, 110, 100, 90, 80, 70, 60, or 50 days, measured according 14855-1 (2012) under home composting conditions. In some cases, the cellulose ester composition (or article comprising same) can be at least about 97, 98, 99, or 99.5 percent biodegradable within not more than about 70, 65, 60, or 50 days of testing according to ISO 14855-1 (2012) under home composting conditions. As a result, the cellulose ester composition (or article comprising same) may be considered biodegradable according to, for example, French Standard NF T 51-800 and Australian Standard AS 5810 when tested under home composting conditions.

The cellulose ester composition (or article comprising same) can exhibit a biodegradation of at least 60 percent in a period of not more than 45 days, when tested under aerobic composting conditions at a temperature of 58° C. (±2° C.) according to ISO 14855-1 (2012). In some cases, the cellulose ester composition (or article comprising same) can exhibit a biodegradation of at least 60 percent in a period of not more than 44, 43, 42, 41, 40, 39, 38, 37, 36, 35, 34, 33, 32, 31, 30, 29, 28, or 27 days when tested under these conditions, also called “industrial composting conditions.” These may not be aqueous or anaerobic conditions. In some cases, the cellulose ester composition (or article comprising same) can exhibit a total biodegradation of at least about 65, 70, 75, 80, 85, 87, 88, 89, 90, 91, 92, 93, 94, or 95 percent, when tested under according to ISO 14855-1 (2012) for a period of 45 days under industrial composting conditions. This may represent a relative biodegradation of at least about 95, 97, 99, 100, 102, 105, 107, 110, 112, 115, 117, or 119 percent, when compared to the same cellulose ester composition (or article comprising same) subjected to identical test conditions.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days. The cellulose ester composition (or article comprising same) described herein may exhibit a biodegradation of at least 90 percent within not more than 180 days, measured according to ISO14855-1 (2012) under industrial composting conditions. In some cases, the cellulose ester composition (or article comprising same) may exhibit a biodegradation of at least about 91, 92, 93, 94, 95, 96, 97, 98, 99, or 99.5 percent within not more than 180 days, or cellulose ester composition (or article comprising same) may exhibit 100 percent biodegradation within not more than 180 days, measured according to ISO 14855-1 (2012) under industrial composting conditions.

Additionally, or in the alternative, cellulose ester composition (or article comprising same) described herein may exhibit a biodegradation of least 90 percent within not more than about 175, 170, 165, 160, 155, 150, 145, 140, 135, 130, 125, 120, 115, 110, 105, 100, 95, 90, 85, 80, 75, 70, 65, 60, 55, 50, or 45 days, measured according to ISO 14855-1 (2012) under industrial composting conditions. In some cases, the cellulose ester composition (or article comprising same) can be at least about 97, 98, 99, or 99.5 percent biodegradable within not more than about 65, 60, 55, 50, or 45 days of testing according to ISO 14855-1 (2012) under industrial composting conditions. As a result, the cellulose ester composition (or article comprising same) described herein may be considered biodegradable according to ASTM D6400 and ISO 17088 when tested under industrial composting conditions.

The cellulose ester composition (or article comprising same) may exhibit a biodegradation in soil of at least 60 percent within not more than 130 days, measured according to ISO 17556 (2012) under aerobic conditions at ambient temperature. In some cases, cellulose ester composition (or article comprising same) can exhibit a biodegradation of at least 60 percent in a period of not more than 130, 120, 110, 100, 90, 80, or 75 days when tested under these conditions, also called “soil composting conditions.” These may not be aqueous or anaerobic conditions. In some cases, the cellulose ester composition (or article comprising same) can exhibit a total biodegradation of at least about 65, 70, 72, 75, 77, 80, 82, or 85 percent, when tested under according to ISO 17556 (2012) for a period of 195 days under soil composting conditions. This may represent a relative biodegradation of at least about 70, 75, 80, 85, 90, or 95 percent, when compared to the same cellulose ester composition (or article comprising same) subjected to identical test conditions.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years.

The cellulose ester composition (or article comprising same) as described herein may exhibit a biodegradation of at least 90 percent within not more than 2 years, 1.75 years, 1 year, 9 months, or 6 months measured according to ISO 17556 (2012) under soil composting conditions. In some cases, the cellulose ester composition (or article comprising same) may exhibit a biodegradation of at least about 91, 92, 93, 94, 95, 96, 97, 98, 99, or 99.5 percent within not more than 2 years, or cellulose ester composition (or article comprising same) may exhibit 100 percent biodegradation within not more than 2 years, measured according to ISO 17556 (2012) under soil composting conditions.

Additionally, or in the alternative, cellulose ester composition (or article comprising same) described herein may exhibit a biodegradation of at least 90 percent within not more than about 700, 650, 600, 550, 500, 450, 400, 350, 300, 275, 250, 240, 230, 220, 210, 200, or 195 days, measured according to ISO 17556 (2012) under soil composting conditions. In some cases, the cellulose ester composition (or article comprising same) can be at least about 97, 98, 99, or 99.5 percent biodegradable within not more than about 225, 220, 215, 210, 205, 200, or 195 days of testing according to ISO 17556 (2012) under soil composting conditions. As a result, the cellulose ester composition (or article comprising same) described herein may meet the requirements to receive. The OK biodegradable SOIL conformity mark of Vinçotte and to meet the standards of the DIN Geprüft Biodegradable in soil certification scheme of DIN CERTCO.

In some embodiments, cellulose ester composition (or article comprising same) of the present invention may include less than 1, 0.75, 0.50, or 0.25 weight percent of components of unknown biodegradability. In some cases, the cellulose ester composition (or article comprising same) described herein may include no components of unknown biodegradability.

Aquatic Biodegradation Test-02 Consumption (OECD 301F) may be used to monitor biodegradation of polymeric materials. OECD 301F is an aquatic aerobic biodegradation test that determines the biodegradability of a material by measuring oxygen consumption. OECD 301F is most often used for insoluble and volatile materials. The purity or proportions of major components of the test material is important for calculating the Theoretical Oxygen Demand (ThOD). Similar to other 301 test methods, the standard test duration for OECD 301F is a minimum of 28 days. A solution, or suspension, of the test substance in a mineral medium is inoculated and incubated under aerobic conditions in the dark or in diffuse light. Cellulose is run in parallel as the positive control to check the operation of the procedures.

Aquatic biodegradation is another measure of the biodegradability of a material of blend of substances. Biological Oxygen Demand [BOD] was measured over time using an OxiTop® Control OC 110 Respirometer system. This is accomplished by measuring the negative pressure that develops when oxygen is consumed in the closed bottle system. NaOH tablets are added to the system to collect the CO₂ given off when 02 is consumed. The CO₂ and NaOH react to form Na₂CO₃, which pulls CO₂ out of the gas phase and causes a measurable negative pressure. The OxiTop measuring heads record this negative pressure value and relay the information wirelessly to a controller, which converts CO₂ produced into BOD due to the 1:1 ratio. The measured biological oxygen demand can be compared to the theoretical oxygen demand of each test material to determine the percentage of biodegradation. In an embodiment of this invention, the Aquatic Biodegradation rate may be the same or different when the alkaline filler is included in a blend.

In addition to being biodegradable under industrial and/or home composting conditions, cellulose ester composition (or article comprising same) as described herein may also be compostable under home and/or industrial conditions. As described previously, a material is considered compostable if it meets or exceeds the requirements set forth in EN 13432 for biodegradability, ability to disintegrate, heavy metal content, and ecotoxicity. The cellulose ester composition (or article comprising same) described herein may exhibit sufficient compostability under home and/or industrial composting conditions to meet the requirements to receive the OK compost and OK compost HOME conformity marks from Vinçotte.

In some cases, the cellulose ester composition (or article comprising same) described herein may have a volatile solids concentration, heavy metals and fluorine content that fulfill all of the requirements laid out by EN 13432 (2000). Additionally, the cellulose ester composition (or article comprising same) may not cause a negative effect on compost quality (including chemical parameters and ecotoxicity tests).

In some cases, the cellulose ester composition (or article comprising same) can exhibit a disintegration of at least 90 percent within not more than 26 weeks, measured according to ISO 16929 (2013) or ISO 20200 under industrial composting conditions. In some cases, the cellulose ester composition (or article comprising same) may exhibit a disintegration of at least about 91, 92, 93, 94, 95, 96, 97, 98, 99, or 99.5 percent under industrial composting conditions within not more than 26 weeks, or cellulose ester composition (or article comprising same) may be 100 percent disintegrated under industrial composting conditions within not more than 26 weeks. Alternatively, or in addition, the cellulose ester composition (or article comprising same) may exhibit a disintegration of at least 90 percent under industrial compositing conditions within not more than about 26, 25, 24, 23, 22, 21, 20, 19, 18, 17, 16, 15, 14, 13, 12, 11, or 10 weeks, measured according to ISO 16929 (2013) or ISO 20200. In some cases, the cellulose ester composition (or article comprising same) described herein may be at least 97, 98, 99, or 99.5 percent disintegrated within not more than 12, 11, 10, 9, or 8 weeks under industrial composting conditions, measured according to ISO 16929 (2013) or ISO 20200.

In some cases, the cellulose ester composition (or article comprising same) can exhibit a disintegration of at least 90 percent within not more than 26 weeks, measured according to ISO 16929 (2013) or ISO 20200 under home composting conditions. In some cases, the cellulose ester composition (or article comprising same) may exhibit a disintegration of at least about 91, 92, 93, 94, 95, 96, 97, 98, 99, or 99.5 percent under home composting conditions within not more than 26 weeks, or the cellulose ester composition (or article comprising same) may be 100 percent disintegrated under home composting conditions within not more than 26 weeks. Alternatively, or in addition, the cellulose ester composition (or article comprising same) may exhibit a disintegration of at least 90 percent within not more than about 26, 25, 24, 23, 22, 21, 20, 19, 18, 17, 16, or 15 weeks under home composting conditions, measured according to ISO 16929 (2013) or ISO 20200. In some cases, the cellulose ester composition (or article comprising same) described herein may be at least 97, 98, 99, or 99.5 percent disintegrated within not more than 20, 19, 18, 17, 16, 15, 14, 13, or 12 weeks, measured under home composting conditions according to ISO 16929 (2013) or ISO 20200.

In one embodiment or in combination with any other embodiments, when the cellulose ester composition is formed into a film or injection molded into an article having a maximum thickness of 0.02, or 0.05, or 0.07, or 0.10, or 0.13, or 0.25, or 0.38, or 0.51, or 0.64, or 0.76, or 0.89, or 1.02, or 1.14, or 1.27, or 1.40, or 1.52, or 1.78, or 2.0, or 2.3, or 2.5, or 3.0, or 3.3, or 3.8 mm, the film or article exhibits greater than 90% disintegration after 12 weeks according to Disintegration Test Protocol, as described in the specification or in the alternative according to ISO 16929 (2013) or ISO 20200. In certain embodiments, when the cellulose ester composition is formed into a film or injection molded into an article having a maximum thickness of 0.02, or 0.05, or 0.07, or 0.10, or 0.13, or 0.25, or 0.38, or 0.51, or 0.64, or 0.76, or 0.89, or 1.02, or 1.14, or 1.27, or 1.40, or 1.52, or 1.78, or 2.0, or 2.3, or 2.5, or 3.0, or 3.3, or 3.8 mm, the film or article exhibits greater than 90% disintegration after 12 weeks according to Disintegration Test Protocol, as described in the specification or in the alternative according to ISO (2013) or ISO 20200. In certain embodiments, when the cellulose ester composition is formed into a film having a thickness of 0.13, or 0.25, or 0.38, or 0.51, or 0.64, or 0.76, or 0.89, or 1.02, or 1.14, or 1.27, or 1.40, or 1.52 mm, the film exhibits greater than 90, or 95, or 96, or 97, or 98, or 99% disintegration after 12 weeks according to Disintegration Test Protocol, as described in the specification or in the alternative according to ISO 16929 (2013) or ISO 20200. In certain embodiments, when the cellulose ester composition is formed into a film or injection molded into an article having a maximum thickness of 0.02, or 0.05, or 0.07, or 0.10, or 0.13, or 0.25, or 0.38, or 0.51, or 0.64, or 0.76, or 0.89, or 1.02, or 1.14, or 1.27, or 1.40, or 1.52, or 1.78, or 2.0, or 2.3, or 2.5, or 3.0, or 3.3, or 3.8 mm, the film or article exhibits greater than 90, or 95, or 96, or 97, or 98, or 99% disintegration after 8, or 9, or 10, or 11, or 12, or 13, or 14, or 15, or 16 weeks according to Disintegration Test Protocol, as described in the specification or in the alternative according to ISO 16929 (2013) or ISO 20200.

In some embodiments, the cellulose ester composition (or article comprising same) described herein may be substantially free of photodegradation agents. For example, the cellulose ester composition (or article comprising same) may include not more than about 1, 0.75, 0.50, 0.25, 0.10, 0.05, 0.025, 0.01, 0.005, 0.0025, or 0.001 weight percent of photodegradation agent, based on the total weight of the cellulose ester composition (or article comprising same), or the cellulose ester composition (or article comprising same) may include no photodegradation agents. Examples of such photodegradation agents include, but are not limited to, pigments which act as photooxidation catalysts and are optionally augmented by the presence of one or more metal salts, oxidizable promoters, and combinations thereof. Pigments can include coated or uncoated anatase or rutile titanium dioxide, which may be present alone or in combination with one or more of the augmenting components such as, for example, various types of metals. Other examples of photodegradation agents include benzoins, benzoin alkyl ethers, benzophenone and its derivatives, acetophenone and its derivatives, quinones, thioxanthones, phthalocyanine and other photosensitizers, ethylene-carbon monoxide copolymer, aromatic ketone-metal salt sensitizers, and combinations thereof.

### End Uses

In one embodiment or in combination with any other embodiment, biodegradable, disintegrable, and/or compostable articles are provided that comprise the cellulose ester compositions, as described herein. In embodiments, the cellulose ester compositions can be extrudable, moldable, castable, thermoformable, or can be 3D printed.

In one embodiment or in combination with any other embodiment, the cellulose ester composition is melt-processable and can be formed into useful molded articles, e.g., single use food contact articles, that are biodegradable and/or compostable. In one embodiment or in combination with any other embodiment, the articles are non-persistent. By environmentally “non-persistent” is meant that when biodegradable cellulose ester reaches an advanced level of disintegration, it becomes amenable to total consumption by the natural microbial population. The degradation of biodegradable cellulose ester ultimately leads its conversion to carbon dioxide, water and biomass. In one embodiment or in combination with any other embodiment, articles comprising the cellulose ester compositions (discussed herein) are provided that have a maximum thickness up to 150 mils, or 140 mils, or 130 mils, or 120 mils, or 110 mils, or 100 mils, or 90 mils, or 80 mils, or 70 mils, or 60 mils, or 50 mils, or 40 mils, or 30 mils, or 25 mils, or 20 mils, or 15 mils, or 10 mils, or 5 mils or 2 mils or 1 mil, and are biodegradable and compostable (i.e., either pass industrial or home compostability tests/criterial as discussed herein). In one embodiment or in combination with any other embodiment, articles comprising the cellulose ester compositions (discussed herein) are provided that have a maximum thickness up to 150 mils, or 140 mils, or 130 mils, or 120 mils, or 110 mils, to 100 mils, or 90 mils, or 80 mils, or 70 mils, or 60 mils, or 50 mils, or 40 mils, or 30 mils, or 25 mils, or 20 mils, or 15 mils, or 10 mils, or 5 mils, or 2 mils, or 1 mil, and are environmentally non-persistent.

In one embodiment or in combination with any other embodiment, articles comprising the cellulose ester composition is provided wherein the article is used in food service and grocery items, horticulture, agriculture, recreation, coatings, fibers, nonwovens, and home/office applications. Example of food service, and grocery items include, but are not limited to, straws, cup lids, composite lids, portion cups, beverage cups, trays, bowl, plates, food containers, container lids, clamshell containers, cutlery, utensils, stirrers, jars, jar lids, bottles, bottle caps, bags, flexible packaging, wrap, produce baskets, produce stickers, and twine. Examples of horticulture and/or agriculture uses include, but are not limited to, plant pots, germination trays, transplant pots, plant tags, buckets, bags for soil & mulch, trimmer string, agricultural film, mulch film, greenhouse film, silage film, compostable bags, film stakes, hay baling twine. Examples of recreation articles include, but are not limited to, toys, sporting goods, fishing tackle, golf gear, and camping goods. Toys can include, but are not limited to, beach toys, blocks, wheels, propellers, sippy cups, doll accessories, and pet toys. Sporting goods can include, but are not limited to, whistles, whiffle balls, paddles, nets, foam balls & darts, and artificial turf). Fishing tackle can include, but are not limited to, floats, lures, nets, and traps. Golf gear includes, but is not limited to, tees, practice balls, ball markers, divot tools. Camping gear includes, but is not limited it, tent stakes, eating utensils, and cord/rope). Examples of home and office articles include, but are not limited to, gift cards, credit cards, signs, labels, report covers, mailers, tape, tool handles, toothbrush handles, writing utensils, combs, film canisters, wire insulation, screw caps, and bottles.

In one embodiment or in combination with any other embodiment, the articles are made from moldable thermoplastic material comprising the cellulose ester compositions, as described herein.

In one embodiment or in combination with any other embodiment, the articles are single use food contact articles. Examples of such articles that can be made with the cellulose ester compositions include cups, trays, multi-compartment trays, clamshell packaging, candy sticks, films, sheets, trays and lids (e.g., thermoformed), straws, plates, bowls, portion cups, food packaging, liquid carrying containers, solid or gel carrying containers, and cutlery. In one embodiment or in combination with any other embodiment, the cellulose ester may be a coating or layer of an article. The articles may comprise fibers. In one embodiment or in combination with any other embodiment, the articles can be horticultural articles. Examples of such articles that can be made with the cellulose ester compositions include plant pots, plant tags, mulch films, and agricultural ground cover.

In one embodiment or in combination with any other embodiment, the cellulose ester has a number average molecular weight (“Mn”) in the range of from 10,000 to 90,000 Daltons, as measured by GPC. In one embodiment or in combination with any other embodiment, the cellulose ester has a number average molecular weight (“Mn”) in the range of from 30,000 to 90,000 Daltons, as measured by GPC. In one embodiment or in combination with any other embodiment, the cellulose ester has a number average molecular weight (“Mn”) in the range of from 40,000 to 90,000 Daltons, as measured by GPC.

In one embodiment or in combination with any other embodiment, wherein when the composition is formed into a film having a thickness of 0.38 mm, the film exhibits greater than 5% disintegration after 6 weeks and greater than 90% disintegration after 12 weeks according to the Disintegration Test Protocol, as described in the specification or in the alternative according to ISO 16929 (2013) or ISO 20200. In one embodiment or in combination with any other embodiment, wherein when the composition is formed into a film having a thickness of 0.38 mm, the film exhibits greater than 10% disintegration after 6 weeks and greater than 90% disintegration after 12 weeks according to Disintegration Test Protocol, as described in the specification or in the alternative according to ISO 16929 (2013) or ISO 20200. In one embodiment or in combination with any other embodiment, wherein when the composition is formed into a film having a thickness of 0.38 mm, the film exhibits greater than 20% disintegration after 6 weeks and greater than 90% disintegration after 12 weeks according to Disintegration Test Protocol, as described in the specification or in the alternative according to ISO 16929 (2013) or ISO 20200. In one embodiment or in combination with any other embodiment, wherein when the composition is formed into a film having a thickness of 0.38 mm, the film exhibits greater than 30% disintegration after 6 weeks and greater than 90% disintegration after 12 weeks according to Disintegration Test Protocol, as described in the specification or in the alternative according to ISO 16929 (2013) or ISO 20200. In one embodiment or in combination with any other embodiment, wherein when the composition is formed into a film having a thickness of 0.38 mm, the film exhibits greater than 50% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 70% disintegration after 6 weeks and greater than 90% disintegration after 12 weeks according to Disintegration Test Protocol, as described in the specification or in the alternative according to ISO 16929 (2013) or ISO 20200.

In one embodiment or in combination with any other embodiment, when the composition is formed into a film having a thickness of 0.76 mm, the film exhibits greater than 30% disintegration after 12 weeks according to Disintegration Test Protocol, as described in the specification or in the alternative according to ISO 16929 (2013) or ISO 20200. In one embodiment or in combination with any other embodiment, when the composition is formed into a film having a thickness of 0.76 mm, the film exhibits greater than 50% disintegration after 12 weeks according to Disintegration Test Protocol, as described in the specification or in the alternative according to ISO 16929 (2013) or ISO 20200. In one embodiment or in combination with any other embodiment, when the composition is formed into a film having a thickness of 0.76 mm, the film exhibits greater than 70% disintegration after 12 weeks according to Disintegration Test Protocol, as described in the specification or in the alternative according to ISO 16929 (2013) or ISO 20200. In one embodiment or in combination with any other embodiment, when the composition is formed into a film having a thickness of 0.76 mm, the film exhibits greater than 90% disintegration after 12 weeks according to Disintegration Test Protocol, as described in the specification or in the alternative according to ISO 16929 (2013) or ISO 20200. In one embodiment or in combination with any other embodiment, when the composition is formed into a film having a thickness of 0.76 mm, the film exhibits greater than 95% disintegration after 12 weeks according to Disintegration Test protocol, as described in the specification or in the alternative according to ISO 16929 (2013) or ISO 20200.

In one embodiment or in combination with any other embodiment, wherein when the composition is formed into an article with a thickness of 3.7 millimeter or less, at least 90% of the article disintegrates in 90 days at 58° C. according to standard ISO 20200, or wherein when the composition is formed into an article with a thickness of 1.89 millimeter or less, at least 90% of the article disintegrates in 90 days at a temperature of from 20° C. to 30° C. according to standard ISO 20200.

In another embodiment, a cellulose acetate tow band is provided comprising a cellulose acetate composition; wherein the cellulose acetate composition comprises at least one cellulose ester, at least one plasticizer, at least one alkaline additive, and at least one neutralizing agent; wherein the cellulose acetate composition is biodegradable according ASTM D6400 when tested under industrial composting conditions.

Typical cigarette filters are made from a continuous-filament tow band of cellulose acetate-based fibers, called cellulose acetate tow, or simply acetate tow. The use of acetate tow to make filters is described in various patents, and the tow may be plasticized. See, for example, U.S. Pat. No. 2,794,239.

Instead of continuous fibers, staple fibers may be used which are shorter, and which may assist in the ultimate degradation of the filters. See, for example, U.S. Pat. No. 3,658,626 which discloses the production of staple fiber smoke filter elements and the like directly from a continuous filamentary tow. These staple fibers also may be plasticized.

Acetate tow for cigarette fibers is typically made up of Y-shaped, small-filament-denier fibers which are intentionally highly crimped and entangled, as described in U.S. Pat. No. 2,953,838. The Y-shape allows optimum cigarette filters with the lowest weight for a given pressure drop compared to other fiber shapes. See U.S. Pat. No. 2,829,027. The small-filament-denier fibers, typically in the range of 1.6-8 denier per filament (dpf), are used to make efficient filters. In constructing a filter, the crimp of the fibers allows improved filter firmness and reduced tow weight for a given pressure drop.

The conversion of acetate tow into cigarette filters may be accomplished by means of a tow conditioning system and a plugmaker, as described, for example, in U.S. Pat. No. 3,017,309. The tow conditioning system withdraws the tow from the bale, spreads and de-registers (“blooms”) the fibers, and delivers the tow to the plugmaker. The plugmaker compresses the tow, wraps it with plugwrap paper, and cuts it into rods of suitable length.

To further increase filter firmness, a nonvolatile solvent may be added to solvent-bond the fibers together. These solvent-bonding agents are called plasticizers in the trade, and historically have included triacetin (glycerol triacetate), diethylene glycol diacetate, triethylene glycol diacetate, tripropionin, acetyl triethyl citrate, and triethyl citrate. Waxes have also been used to increase filter firmness. See, for example, U.S. Pat. No. 2,904,050.

Conventional plasticizer fiber-to-fiber bonding agents work well for bonding and selective filtration. However, plasticizers typically are not water-soluble, and the fibers will remain bonded over extended periods of time. In fact, conventional cigarette filters can require years to degrade and disintegrate when discarded, due to the highly entangled nature of the filter fibers, the solvent bonding between the fibers, and the inherent slow degradability of the cellulose acetate polymer. Attempts have therefore been made to develop cigarette filters having improved degradability.

### Specific Embodiments

Embodiment 1. A melt processable cellulose ester composition comprising:
   at least one cellulose ester, at least one alkaline additive, and at least one neutralizing agent; wherein a 1 weight % suspension of said alkaline filler has a pH of 8 or greater; wherein the water-solubility of said alkaline filler at 20-25° C. is greater than 1 ppm but less than 1,000 ppm; and wherein said alkaline filler is present in an amount of about 0.1 weight % to about 35 weight % based on the weight of the cellulose ester composition; or
   at least one cellulose acetate, at least one plasticizer, at least one alkaline additive, and at least one neutralizing agent; wherein a 1 weight % suspension of said alkaline addition has a pH of 8 or greater; wherein the water-solubility of said alkaline filler at 20-25° C. is greater than 1 ppm but less than 1,000 ppm; and wherein said alkaline filler is present in an amount of about 0.1 weight % to about 35 weight % based on the weight of the cellulose ester composition.
Embodiment 2. The melt processable cellulose ester composition of Embodiment 1, wherein the alkaline filler is present at an amount of about 0.1 weight % to about 10 weight % based on the weight of the cellulose ester composition.
Embodiment 3. The melt processable cellulose ester composition according to any one of Embodiments 1-2, wherein said cellulose ester is cellulose acetate.
Embodiment 4. The melt processable cellulose ester composition according to any one of Embodiment 1-3, wherein said cellulose ester is prepared by converting cellulose to a cellulose ester with reactants that are obtained from recycled materials.
Embodiment 5. The melt processable cellulose ester composition according to any one of Embodiments 1-4, wherein said plasticizer is at least one selected from the group consisting of glycerol triacetate (Triacetin), glycerol diacetate, dibutyl terephthalate, dimethyl phthalate, diethyl phthalate, poly(ethylene glycol) MW 200-600, triethylene glycol dipropionate, 1,2-epoxypropylphenyl ethylene glycol, 1,2-epoxypropyl(m-cresyl) ethylene glycol, 1,2-epoxypropyl(o-cresyl) ethylene glycol, β-oxyethyl cyclohexenecarboxylate, bis(cyclohexanate) diethylene glycol, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, triethyl citrate, acetyl triethyl citrate, polyethylene glycol, the benzoate containing plasticizers such as the Benzoflex™ plasticizer series, poly(alkyl succinates) such as poly(butyl succinate), polyethersulfones, adipate based plasticizers, soybean oil epoxides such as the Paraplex™ plasticizer series, sucrose based plasticizers, dibutyl sebacate, tributyrin, tripropionin, sucrose acetate isobutyrate, the Resolflex™ series of plasticizers, triphenyl phosphate, glycolates, methoxy polyethylene glycol, 2,2,4-trimethylpentane-1,3-diyl bis(2-methylpropanoate), and polycaprolactones.
Embodiment 6. The melt processable cellulose ester composition according to any one of Embodiments 1-5 wherein said plasticizer is present in an amount from 1 to 40 wt %.
Embodiment 7. The melt processable cellulose ester composition according to any one of Embodiments 1-6 wherein said cellulose ester composition comprises a biodegradable cellulose ester (BCE) component and at least one other biodegradable polymer other than the BCE.
Embodiment 8. The melt processable cellulose ester composition according to any one of Embodiments 1-7 wherein the pH of a 1 weight % solution or suspension of said alkaline filler ranges from about 8 to about 12.
Embodiment 9. The melt processable cellulose ester composition according to any one of Embodiments 1-8 wherein the water-solubility of said alkaline filler at 20-25° C. is about 2 ppm to about 400 ppm.
Embodiment 10. The melt processable cellulose ester composition according to any one of Embodiments 1-9 wherein the pH of a 1 weight % suspension of the alkaline filler is 8 or greater, and the alkaline efficiency is at least 5.
Embodiment 11. The melt processable cellulose ester composition according to any one of Embodiments 1-10, wherein the alkaline efficiency is at least 6.
Embodiment 12. The melt processable cellulose ester composition according to any one of Embodiments 1-11, wherein the alkaline filler is at least one selected from the group consisting of calcium carbonate (CaCO₃), magnesium oxide (MgO), magnesium hydroxide (Mg(OH)₂), magnesium carbonate (MgCO₃), barium carbonate (BaCO₃), and hydrated forms of these compounds.
Embodiment 13. The melt processable cellulose ester composition according to any one of Embodiments 1-12, wherein the alkaline filler is a mixture of calcium carbonate and at least one of the following of magnesium oxide, magnesium hydroxide, or magnesium carbonate, wherein the calcium carbonate is present at from 5 to 25 weight %, and the at least one of the following of magnesium oxide, magnesium hydroxide, or magnesium carbonate is present at from 1 to 20 weight % based on the total weight of the cellulose ester composition.
Embodiment 14. The melt processable cellulose ester composition according to any one of Embodiments 1-13 wherein said alkaline filler undergoes volumetric expansion.
Embodiment 15. The melt processable cellulose ester composition according to any one of Embodiments 1-14, wherein said alkaline filler is present at between about 10 weight % and about 20 weight % in said cellulose ester composition by weight.
Embodiment 16. The melt processable cellulose ester composition according to any one of Embodiments 1-15, wherein said neutralizing agent is at least one selected from the group consisting of citric acid, malic acid, succinic acid, adipic acid, fumaric acid, formic acid, lactic acid, maleic acid, tartaric acid, malonic acid, glutamic acid, glutaric acid, gluconic acid, isophthalic acid, terephthalic acid, glycolic acid, itaconic acid, ferulic acid, mandelic acid, aconitic acid, benzoic acid, aspartic acid, and vanillic acid.
Embodiment 17. The melt processable cellulose ester composition according to any one of Embodiments 1-16, wherein the neutralizing agent has a pKa of 4.5 or lower and a boiling point or a decomposition temperature of 170° C. or greater.
Embodiment 18. The melt processable cellulose ester composition according to any one of Embodiments 1-17, wherein the neutralizing agent is citric acid, adipic acid, or fumaric acid.
Embodiment 19. The melt processable cellulose ester composition according to any one of Embodiments 1-18, wherein about 0.5 weight % to about 5 weight % of the neutralizing agent is present in said cellulose ester composition based on the weight of the cellulose ester composition.
Embodiment 20. The melt processable cellulose ester composition according to any one of Embodiments 1-19, wherein when the composition is formed into an article with a thickness of 3.7 millimeter or less, at least 90% of the article disintegrates in 90 days at 58° C. according to standard ISO 20200, or wherein when the composition is formed into an article with a thickness of 1.89 millimeter or less, at least 90% of the article disintegrates in 90 days at a temperature of from 20° C. to 30° C. according to standard ISO 20200.

### EXAMPLES

### Abbreviations

CA is cellulose acetate; mm is millimeter(s); TA is triacetin; wt is weight; wt % is weight percent; g is gram; ° C. is degree(s) Celsius; ° F. is degree(s) Fahrenheit; mL is milliliter; L is liter; ppm is parts per million; CAP is cellulose acetate propionate; h is hour; TGA is thermogravimetric analysis; TDS is total dissolved solids; EC is electrical conductivity;

### Example 1. Free Alkali Content of Mineral Fillers

Free alkali of mineral fillers was determined by titration. Boil 2.0 g test material with 100 ml of water for 5 minutes in a covered beaker and filter while hot. Titrate 50 mL of the cooled filtrate with 0.10 N sulfuric acid.

TABLE 3

| | Free alkali |
|---|---|
| Filler | (mmol/g) |
| CaCO₃- Heliacal3000 | 0.0367 |
| Mg(OH)₂ - ICL USP | 0.0828 |
| MgO - Marinco FCC | 0.8201 |

### Example 2. CA Formulations were Melt-Processed

Compounded pellets: An 18 mm (Leistritz) twin screw extruder with a single-hole die was used to extrude pellets which were then later used for the film extrusion. These pellets were made from raw materials consisting of a powder cellulose acetate, CA-398-30, obtained from Eastman Chemical Company, a liquid plasticizer (either polyethylene glycol (PEG400) or TA) and additives. Any dry ingredients were added to the base powder and dry-blended to produce a free-flowing powder and added to a (Coperion) twin-screw weight-loss feeder. The plasticizer was fed into zone 2 by a liquid injection unit accompanied by a (Witte) gear pump, Hardy 4060 controller, and injector with a 0.020″ bore. Compounded strands were run through a water trough and pelletized (using a ConAir pelletizer).

Film extrusion: A (1.5 inch Killion) single screw extruder equipped with (Maddock) mixer screw was used to produce films. Formulated cellulose acetate pellets were loaded into the hopper and material passed into the barrel where the mixer screw transferred the material toward the die. The barrel housing the screw was heated in three zones so that the pellets would melt as they passed over the screw along a very narrow clearance allowing for a high shear and high degree of dispersive mixing. It was observed that a homogeneous polymer mixture was formed as it approached the die and the mixture was forced through the die by the screw where extrusion occurs. The extrusion formed a flat molten film as the film exited the die and the film solidified on temperature controlled polished chrome rolls (the roll stack). Post-extrusion film samples were removed intermittently to determine film thickness. When the extruder was producing the proper film thickness, the film was attached to a receiving roller and the film was carefully wound until the final roll was complete.

### Example 3 (Counter Example)

MgO at 5 wt % in a formulation with plasticizer and CA cannot be compounded in the absence of a neutralizing agent.

The formulations with only CA, plasticizer and alkaline filler at 5 wt % were not successfully melt processed. Cellulose acetate (CA-398-30) plasticized with 20 wt % Triacetin (TA) or 20 wt % PEG 400 and 5 wt % MgO was compounded according to Example 3. The compounded pellets for formulations 4 and 6 were porous and brittle with a strong odor and dark color, and intact films could not be extruded from the pellets.

TABLE 4

| # | Plasticizer (wt %) | Filler (wt %) | Status |
|---|---|---|---|
| 4 | Triacetin (20) | MgO (5) | FAIL |
| 6 | PEG400 (20) | MgO (5) | FAIL |

### Example 4. Appearance of Melt-Processed Formulations of Plasticized CA

Melt-processed CA formulations were characterized for their appearance. After compounding pellets, 30 mil thick films were extruded as in Example 2, and 60 mil plaques were injection molded. Alkaline fillers and neutralizing agents were included in some of the formulations, and the appearance of the melt-processed articles was assessed.

Color of the 60 mil plaques was measured in CIE L*a*b* color space against a white background using a Konika Minolta Chroma Meter, CR-400, and SpectraMagic NX software. The L* value is a measure of brightness, with L*=0 being black and L*=100 being white. The color of a plaque was characterized as “light” if the L* value was >50.

Opacity was measured as the percent transmittance of light (% T, 600 nm) through a 30 mil extruded film, using a Beckman DU530 spectrophotometer. Transparency was assessed as the color difference (Delta E) of a white and black surface as measured through a 30 mil extruded film. The appearance of the test articles is summarized in Table 5.

TABLE 5

| Trait | Test material | Measure | Target |
|---|---|---|---|
| Color | 60 mil plaque against | L* (white- | L* > 50 |
| | a white background | black axis) | |
| Opacity | 30 mil extruded film | % T at 600 nm | % T > 1.0 |
| Transparency | 30 mil extruded film, | Delta E (CIE76) | Delta E > 20 |
| | against white vs | | |
| | black background | | |
| | (Leneta chart) | | |

(BHT = Butylated hydroxytoluene)

TABLE 6

| | | | | | | | |
|---|---|---|---|---|---|---|---|
| | | Alkaline | Neutralizing | Other | | | |
| Sample | Plasticizer | additive | Agent | Additives | | | Delta |
| # | (wt %) | (wt %) | (wt %) | (wt %) | L* | % T | E |

| | | | | | | |
|---|---|---|---|---|---|---|
| 27 | Triacetin (20) | | | 91.9 | 87.2 | 58.1 |
| 9 | PEG400 (20) | | | 93.2 | 90.0 | 59.6 |
| 18 | PEG400 (20) | | BHT (0.1) | 93.3 | 89.1 | 59.5 |
| 10 | PEG400 (20) | CaCO₃ (5) | | 72.2 | 0.40 | 9.6 |
| 30 | PEG400 (20) | CaCO₃ (5) | | 76.0 | 0.38 | 8.9 |

### Example 5. Melt-Processed Articles with a MgO Content Less than 5 wt % and Citric or Malic Acid as Neutralizing Agent

Melt-processed CA-398-30 formulations were characterized for their appearance according to Example 4. The appearance of the test formulations was characterized as summarized in Table 7.

TABLE 7

| | | Alkaline | Neutralizing | | | |
|---|---|---|---|---|---|---|
| Sample | Plasticizer | additive | Agent | | | Delta |
| # | (wt %) | (wt %) | (%) | L* | % T | E |
| 63 | Triacetin (20) | MgO (1) | Citric Acid (0.5) | 84.0 | 12.0 | 37.8 |
| 64 | Triacetin (20) | MgO (2) | Citric Acid (0.5) | 61.7 | 1.2 | 22.6 |
| 14 | Triacetin (20) | MgO (2) | Citric acid (0.5) | 56.9 | 1.4 | 22.9 |
| 21 | Triacetin (20) | MgO (2) | Malic acid (0.5) | 59.6 | 1.0 | 20.3 |
| 59 | PEG 400 (15) | MgO (1) | Citric Acid (0.5) | 88.3 | 14.2 | 41.3 |
| 60 | PEG 400 (15) | MgO (2) | Citric Acid (0.5) | 81.6 | 1.7 | 25.5 |
| 16 | PEG 400 (20) | MgO (2) | Citric acid (0.5) | 84.8 | 2.0 | 27.3 |
| 23 | PEG 400 (20) | MgO (2) | Malic acid (0.5) | 70.8 | 2.2 | 27.6 |

### Example 6. Melt Processed Articles with 2 to 5 wt % MgO

The appearance of melt-processed articles with 2 to 5 wt % MgO, including addition of antioxidant (BHT), chelating agent (EDA) and/or whitener (TiO₂). Melt-processed CA398-30 formulations were characterized for their appearance according to Example 4. In Table 8 below, the appearance of the test articles is summarized.

(BHT=Butylated hydroxytoluene; EDA=Etidronic acid)

TABLE 8

| | | Alkaline | Neutralizing | Other | | | |
|---|---|---|---|---|---|---|---|
| Sample | Plasticizer | additive | Agent | additives | | | Delta |
| # | (wt %) | (wt %) | (wt %) | (wt %) | L* | % T | E |
| 3 | Triacetin (20) | MgO (2) | | | 33.7 | 0.91 | 14.3 |
| 5 | PEG 400 (20) | MgO (2) | | | 29.6 | 2.3 | 18.6 |
| 31 | PEG 400 (20) | MgO (5) | Succinic acid (1) | BHT (0.1) | 40.3 | 0.24 | 5.6 |
| 32 | PEG 400 (20) | MgO (5) | Succinic acid (1) | BHT (0.1), | 46.4 | 0.37 | 9.4 |
| | | | | EDA (0.6) | | | |
| 33 | PEG 400 (20) | MgO (5) | Succinic acid (1) | BHT (0.1), | 70.6 | 0.03 | 0.11 |
| | | | | TiO₂ (1) | | | |
| 28 | PEG 400 (20) | MgO (5) | Citric acid (1) | | 71.4 | 0.55 | 16.7 |
| 35 | PEG 400 (20) | MgO (5) | Citric acid (1) | BHT (0.1) | 66.1 | 0.54 | 15.2 |
| 34 | PEG 400 (20) | MgO (5) | Citric acid (1) | BHT (0.1), | 76.5 | 0.06 | 0.55 |
| | | | | TiO₂ (1) | | | |
| 47 | PEG400 (20) | MgO (5) | Citric Acid (1.5) | | 88.7 | 0.66 | 19.8 |

### Example 7. Melt-Processed Articles with Mg(OH)₂ as an Alkaline Additive

Color and transparency improve when a neutralizing agent is added to a melt-processed article with Mg(OH)₂. Mg(OH)₂ can be included at up to 5% in a melt-processed formulation with a neutralizing agent.

Melt-processed CA-398-30 formulations were characterized for their appearance according to Example 4. In Table 9 below, test formulations were evaluated for appearance.

TABLE 9

| | | Alkaline | Neutralizing | | | |
|---|---|---|---|---|---|---|
| Sample | Plasticizer | additive | Agent | | | Delta |
| # | (wt %) | (wt %) | (wt %) | L* | % T | E |
| 65 | Triacetin (20) | Mg(OH)₂ (1) | Citric Acid (0.5) | 85.6 | 18.4 | 42.4 |
| | | 1 | | | | |
| 19 | Triacetin (20) | Mg(OH)₂ (2) | | 81.9 | 9.5 | 38.4 |
| 15 | Triacetin (20) | Mg(OH)₂ (2) | Citric acid 0.05) | 84.8 | 9.8 | 39.4 |
| 66 | Triacetin (20) | Mg(OH)₂ (2) | Citric Acid (0.5) | 84.8 | 10.6 | 36.7 |
| 22 | Triacetin (20) | Mg(OH)₂ (2) | Malic acid 0.05) | 85.2 | 7.2 | 36.5 |
| 61 | PEG 400 (15) | Mg(OH)₂ (1) | Citric Acid (0.5) | 86.5 | 20.0 | 44.6 |
| 11 | PEG 400 (20) | Mg(OH)₂ (2) | | 61.2 | 10.3 | 48.9 |
| 17 | PEG 400 (20) | Mg(OH)₂ (2) | Citric acid 0.05) | 85.7 | 13.1 | 41.0 |
| 62 | PEG 400 (15) | Mg(OH)₂ (2) | Citric Acid (0.5) | 86.2 | 10.1 | 38.7 |
| 24 | PEG 400 (20) | Mg(OH)₂ (2) | Malic acid (0.05) | 86.1 | 10.0 | 41.6 |
| 29 | PEG 400 (20) | Mg(OH)₂ (5) | Citric Acid (0.1) | 76.6 | 1.6 | 27.2 |

### Example 8. Aquatic Biodegradation of CA Resin with 2 wt % MgO

The screening test for freshwater aquatic biodegradation was based on OECD 301F Manometric Respirometry Test. Biological Oxygen Demand [BOD] was measured over time using an OxiTop® Control OC 110 Respirometer system. Eastman sludge was used as the wastewater inoculum, vacuum filtered to remove solid particles. The test was run for 56 days. The longer duration allows the test to be used for screening materials that may be classified as either readily or inherently biodegradable.

The CA resin (Eastman CA398-30) was formulated as a blend with plasticizer (PEG400 at 15 wt %) and optionally alkaline additive, MgO at 2 wt %. The components of the formulations were accurately weighed and mixed well. Close agreement between the three independent replicates verified good mixing of the components. The formulations were not melt-processed or dissolved prior to the aquatic biodegradation test. The initial pH of the mineral media was 7.48. 2 wt % MgO had no impact on rate of biodegradation of CA-398-30 with PEG400 in a blend.

TABLE 10
Aquatic Biodegradation

| | % | % |
|---|---|---|
| | Biodegradation | Biodegradation |
| | at 28 days | at 56 days |
| Test material | Average | Average |
| Cellulose | 74.79 | 78.97 |
| (positive control) | | |
| CA398-30 | 56.23 | 69.48 |
| 85 wt % CA398-30 + | 60.23 | 72.58 |
| 15 wt % PEG400 | | |
| 83 wt % CA398-30 + | 60.37 | 73.26 |
| 14.7 wt % PEG400 + | | |
| 2 wt % MgO | | |

### Example 9. Disintegration in Industrial Compost (OWS SAW-27)

A qualitative screening test was based on ISO 16929, to monitor the disintegration of test articles was evaluated during 12 weeks of composting, simulating industrial composting conditions. The 30 mil extruded film test materials of Examples 4 to 7 were added as 10 cm×10 cm pieces, mixed with biowaste and composted in 200 Liter composting bins. The mixture in the bins was regularly turned manually during which the disintegration of the test item was visually monitored.

After 12 weeks of composting, only a few tiny test item pieces were found for test items for Material #9, 10, 16, 17, 28, and 29 (Test codes NZ-46, NZ-47, NZ-49, NZ-50, NZ-52, NZ-53). In contrast, large pieces of test items for Material #18, and #30 (Test code NZ-51, NZ-54) could be retrieved from the test bin. A summary of the most notable visual observations and changes during the disintegration of the test items is given in Table 12.

TABLE 11

| | | | Neutralizing | | | |
|---|---|---|---|---|---|---|
| Sample | Plasticizer | Filler | Agent | Other | Test | |
| # | (wt %) | (wt %) | (wt %) | additives | code | Thickness |
| 9 | PEG400 (20) | | | | NZ-46 | 30 mil |
| 18 | PEG400 (20) | | | 0.1% BHT | NZ-51 | 30 mil |
| 10 | PEG400 (20) | CaCO₃ (15) | | | NZ-47 | 30 mil |
| 30 | PEG400 (20) | CaCO₃ (15) | Citric acid (0.1) | | NZ-54 | 30 mil |
| 16 | PEG400 (20) | MgO (2) | Citric acid (0.5) | | NZ-49 | 30 mil |
| 28 | PEG400 (20) | MgO (5) | Citric acid (1) | | NZ-52 | 30 mil |
| 17 | PEG400 (20) | Mg(OH)₂ (2) | Citric acid (0.05) | | NZ-50 | 30 mil |
| 29 | PEG400 (20) | Mg(OH)₂ (5) | Citric Acid (0.1) | | NZ-53 | 30 mil |

TABLE 12

| | Code | | |
|---|---|---|---|
| # | (alkaline filler) | 4 weeks | 8 weeks |
| 9 | NZ-46 | Remained completely intact, | Broken into large pieces, |
| | (no filler) | fungal growth and | fungal growth and |
| | | discolouring | discolouring |
| 18 | NZ-51 | Remained completely intact, | Remained completely intact, |
| | (no filler) | fungal growth and | fungal growth and |
| | | discolouring | discolouring |
| 10 | NZ-47 | Started to break into pieces, | Broken into large pieces, |
| | (15 wt % | fungal growth and | fungal growth and |
| | CaCO₃) | discolouring | discolouring |
| 30 | NZ-54 | Remained completely intact, | Remained completely intact, |
| | (15 wt % | fungal growth and | fungal growth and |
| | CaCO₃) | discolouring | discolouring |
| 16 | NZ-49 | Started to break into | Broken into large pieces, |
| | (2 wt % | pieces, fungal growth and | fungal growth and |
| | MgO) | discolouring | discolouring |
| 28 | NZ-52 | Small tears in a few test | A few small pieces were |
| | (5 wt % | items, fungal growth and | retrieved from the bin, |
| | MgO) | discolouring | fungal growth and |
| | | | discolouring |
| 17 | NZ-50 | Tears and holes in minor | Large pieces were seen in |
| | (2 wt % | part of the test item, fungal | the test bin, fungal growth |
| | Mg(OH)2) | growth and discolouring | and discolouring |
| 29 | NZ-53 | Started to break into | Pieces of variable size |
| | (5 wt % | pieces, fungal growth and | were seen in the bin, |
| | Mg(OH)2) | discolouring | fungal growth and |
| | | | discolouring |

TABLE 13
Disintegration after 12 weeks

| | | | Neutralizing | | | |
|---|---|---|---|---|---|---|
| | Plasticizer | Filler | Agent | Other | Test | Disintegration |
| # | (%) | (%) | (%) | additives | code | after 12 weeks |
| 9 | PEG400 (20) | | | | NZ-46 | Progressed - few |
| | | | | | | tiny test pieces |
| 18 | PEG400 (20) | | | BHT (0.1) | NZ-51 | Incomplete |
| 10 | PEG400 (20) | CaCO₃ (15) | | | NZ-47 | Progressed - few |
| | | | | | | tiny test pieces |
| 30 | PEG400 (20) | CaCO₃ (15) | Citric acid (0.1) | | NZ-54 | Incomplete |
| 16 | PEG400 (20) | MgO (2) | Citric acid (0.5) | | NZ-49 | Progressed - few |
| | | | | | | tiny test pieces |
| 28 | PEG400 (20) | MgO (5) | Citric acid (1) | | NZ-52 | Progressed - few |
| | | | | | | tiny test pieces |
| 17 | PEG400 (20) | Mg(OH)₂ (2) | Citric acid (0.05) | | NZ-50 | Progressed - few |
| | | | | | | tiny test pieces |
| 29 | PEG400 (20) | Mg(OH)₂ (5) | Citric Acid (0.1) | | NZ-53 | Progressed - few |
| | | | | | | tiny test pieces |

### Example 10. Disintegration of 60 Mil Injection Molded Plaques in Home Compost Bins

CA398-30 was compounded with Triacetin (TA) or PEG400 and optionally CaCO₃ or MgO, according to Table 15. Plaques (4 inches square and 0.060 inches thick) were injection molded from the compounded pellets. Plaques were cut into 1-inch by 4-inch strips, labeled with colored duct tape and weighed. Then 12 pieces of each test article were placed a domestic outdoor compost bin.

The compost bins were outdoor black plastic tumblers sold for domestic use with a total capacity of 140 Liters. The bins were placed outdoors and filled to the central axis (about 70 Liters) with mature industrial compost from a local supplier. Additional feedstock was added: about 24 Liters of pine shavings and about 6 Liters of alfalfa pellets (retail adult rabbit food). Water was added to about 60% using the squeeze test. The bins were rotated about once a week. After rotating, the bins were opened to make sure all samples were submerged in the compost. The compost was fed 0.5 L of alfalfa pellets every 6 weeks. The compost pH varied between 6 and 7.5, while the C:N ratio was between 7 and 17.

Triplicate samples of each test material were retrieved from the outdoor tumblers after 8, 14, 20 and 26 weeks. The samples were cleaned of surface debris, dried and re-weighed. The presence of 5 wt % MgO or 15 wt % CaCO₃ increased degradation measured as weight loss in the home compost bins.

TABLE 14
Composition of injection molded plaques, 60 mil thick

| | | | | Average % |
|---|---|---|---|---|
| | | | | wt loss after |
| | | | | 26 weeks |
| | Plasticizer | Promoter | Neutralizing | in home |
| Sample # | (wt %) | (wt %) | agent (wt %) | compost bin |
| 27 | TA (20) | | | 14.5 |
| 3 | TA (20) | MgO (2) | none | 32.8 |
| 19 | TA (20) | Mg(OH)₂ (2) | none | 24.4 |
| 9 | PEG400 (20) | | | 30.0 |
| 5 | PEG400 (20) | MgO (2) | none | 51.3 |
| 11 | PEG400 (20) | Mg(OH)₂ (2) | none | 41.7 |
| 30 | PEG400 (20) | CaCO₃ (15) | citric | 35.7 |
| | | | acid (0.1) | |

### Example 11. Disintegration of 125 Mil Injection Molded Tensile Bars in Home Compost Bins

CA398-30 was compounded with PEG400 and optionally CaCO₃ or MgO, according to Table 16. Tensile bars (aka dog bones, 8.5 inches long, ⅕ to ¾ inches wide and 0.125 inches thick) were injection molded from the compounded pellets. Tensile bars were cut in half, labeled with colored duct tape and weighed. Then 12 pieces of each test article were placed a domestic outdoor compost bin.

The compost bins were outdoor black plastic tumblers sold for domestic use with a total capacity of 140 Liters. The bins were placed outdoors and filled to the central axis (about 70 Liters) with mature industrial compost from a local supplier. Additional feedstock was added: about 24 Liters of pine shavings and about 6 Liters of alfalfa pellets (retail adult rabbit food). Water was added to about 60% using the squeeze test. The bins were rotated about once a week. After rotating, the bins were opened to make sure all samples were submerged in the compost. The compost was fed 0.5 L of alfalfa pellets every 6 weeks. The compost pH varied between 6 and 7.5, while the C:N ratio was between 10 and 13.

Triplicate samples of each test material were retrieved from the outdoor tumblers after 8, 14, 20 and 26 weeks. The samples were cleaned of surface debris, dried and re-weighed. The presence of CaCO₃ (15 wt %) or MgO (5 wt %) increased degradation measured as weight loss in the home compost bins.

TABLE 15
Composition of injection molded bars, 125 mil thick

| | | | | Average % |
|---|---|---|---|---|
| | | | | wt loss after |
| | | | | 26 weeks |
| | | Alkaline | Neutralizing | in home |
| Sample # | Plasticizer | additive | agent | compost bin |
| 41 | PEG400 (20) | | | 25.5 |
| 42 | PEG400 (20) | CaCO₃ (15) | Citric | 26.9 |
| | | | acid (0.1) | |
| 43 | PEG400 (20) | MgO (5) | Citric | 53.9 |
| | | | acid (0.5) | |

### Example 12. Disintegration of 50-130 Mil Injection Molded Cutlery in Home Compost Bins

CA-398-30 was compounded with PEG400 and optionally CaCO₃ or MgO, according to Table 16. Cutlery was injection molded from the compounded pellets. Knives were labeled with colored duct tape and weighed. Then 12 pieces of each test article were placed a domestic outdoor compost bin.

The compost bins were outdoor black plastic tumblers sold for domestic use with a total capacity of 140 Liters. The bins were placed outdoors and filled to the central axis (about 70 Liters) with mature industrial compost from a local supplier. Additional feedstock was added: about 24 Liters of pine shavings and about 6 Liters of alfalfa pellets (retail adult rabbit food). Water was added to about 60% using the squeeze test. The bins were rotated about once a week. After rotating, the bins were opened to make sure all samples were submerged in the compost. The compost was fed 0.5 L of alfalfa pellets every 6 weeks. The compost pH varied between 6 and 7.5, while the C:N ratio was between 10 and 13.

Samples of each test material were retrieved from the outdoor tumblers after 26 weeks. The samples were cleaned of surface debris, dried and re-weighed. The presence of 2 to 5 wt % MgO or 2 to 5 wt % Mg(OH)₂ increased degradation measured as weight loss in the home compost bins.

TABLE 16
Composition of injection molded knives, 50-130 mil thick

| | | | | Average % |
|---|---|---|---|---|
| | | | | wt loss after |
| | | | | 26 weeks |
| | | | | in home |
| | | Alkaline | Neutralizing | compost bin |
| Material # | Plasticizer | additive | agent | (n = 9) |
| 88 | PEG400 (15) | | | 25.8 |
| 381 | PEG400 (15) | 2% MgO (2) | Citric | 56.9 |
| | | | acid (0.5) | |
| 382 | PEG400 (15) | 2% Mg(OH)₂ (2) | Citric | 59.1 |
| | | | acid (0.5) | |
| 89 | PEG400 (15) | MgO (5) | Citric | 88.4 |
| | | | acid (0.5) | |
| 90 | PEG400 (15) | Mg(OH)₂ (5) | Citric | 72.3 |
| | | | acid (0.5) | |

### Example 13. Disintegration in an Industrial Compost Field Trial

An industrial composting field test was conducted at a facility using a turned windrow system. The test articles were photographed, tagged and placed in a nylon mesh bag. The mesh bags were filled with compost and placed in the windrows at the start of the active phase of composting. In the trial, the starting feedstock C:N ratio averaged about 24. The average temperature in the windrows over the 90 day active phase was about 160F, and the moisture content varied between 50 & 60%. The pile was further subjected to a curing phase for an additional 90 days. After recovering the test articles from the mesh bags, the % disintegration was estimated from images of the partially disintegrated test articles.

TABLE 17

| | | Status | % | Status | % |
|---|---|---|---|---|---|
| | | after | Disintegrated | after | Disintegrated |
| | Composition of | 90 day | after 90 d | 90 day | after 90 d |
| Sample | 30 mil extruded | active | active phase | curing | curing phase |
| # | films (wt %) | phase | (estimate) | phase | (estimate) |
| 9 | PEG400 (20) | FAIL | 10% | FAIL | 10% |
| 10 | PEG400 (20), | FAIL | 10% | FAIL | 20% |
| | CaCO₃ (15) | | | | |
| 28 | PEG400 (20), | (partial) | 50% | PASS | >95% |
| | MgO(5), Citric | | | | |
| | acid (1) | | | | |
| 29 | PEG400 (20), | FAIL | 10% | (partial) | 50% |
| | Mg(OH)₂(5), | | | | |
| | Citric | | | | |
| | acid (0.1) | | | | |

### Example 14. Hydrated MgCO₃, Hydromagnesite and Basic Magnesium Carbonate, as Alkaline Additives

Hydromagnesite (Hydrated MgCO₃) was precipitated from solutions of soluble salts. Precipitations were conducted at 90° C. The starting materials were USP grade MgSO₄·7H₂O and food grade Sodium bicarbonate. For the precipitation reactions a 0.5M Mg salt solution was heated to at least 70° C. before slowly adding the sodium bicarbonate solid while stirring, then the reaction was held at 90° C. overnight. The resulting solid precipitate was washed with DI water until TDS of the filtrate measured less than 120 ppm on a portable EC meter. The precipitate was dried to a constant weight and passed through a screen to break up lumps. The identity of the reaction product as Hydromagnesite was confirmed by TGA and from a plate-like crystal morphology using SEM. The molecular formula of Hydromagnesite is 4MgCO₃·Mg(OH)₂·4H₂O.

Basic Magnesium Carbonate (BMC 320-FCC, Brenntag Specialty Ingredients) was estimated by TGA to have about 3 molecules of bound water, with a suggested molecular formula like Artinite of 4MgCO₃·Mg(OH)₂·3H₂O

The pH of a 1% suspension of different Mg-based alkaline minerals was estimated using colorimetric pH strips, while the total dissolved solids (TDS) of the of the 1 wt % suspension was measured at 21 C with a portable electrical conductivity (EC) meter and reported as ppm.

TABLE 18
Physical and chemical properties MgCO₃ forms
(1 wt % suspension in water; measured)

| Mineral name | Formula | pH | TDS, ppm |
|---|---|---|---|
| Magnesia | MgO | 9-10 | 105 |
| Brucite | Mg(OH)₂ | 10 | 67 |
| Magnesite | MgCO₃ (anhydrous) | 10-11 | nd |
| Nesquehonite | MgCO₃ · 3H₂O | 9.5 | 425 |
| Artinite (BMC) | 4MgCO₃ · Mg(OH)₂ · 3H₂O | 8 | 71 |
| Hydromagnesite | 4MgCO₃ · Mg(OH)₂ · 4H₂O | 8-8.5 | 120 |
| Dypingite | 4MgCO₃ · Mg(OH)₂ · 5H₂O | nd | nd |

nd = no data

Dry blends of CA-398-30 with 5 wt % MgCO₃ (hydrates) and 15 wt % PEG400 were made by sieving together the dry ingredients 3 times to mix and disperse the mineral additive in the CA powder. Then PEG400 was added, and the mixture was blended together in an electric grinder to disperse the plasticizer. Each dry blend was weighed into aluminum pans and dried at 80° C. for 24 h. Films (10 and 20 mil) were pressed for a total of 4 minutes on a heated press with the upper and lower platens pre-heated to 425° F. (218 C). The pre-dried CA/PEG400/MgO/acid dry blend was applied to the center of a 4-inch square, 10 mil thick frame between a top and bottom layer of aluminum foil, all between two steel plates. The assembly was placed in the press and heated for 1 min at 0 pressure to dry and pre-melt the puck, then pressed for 1 minute at 12,000 PHI, bumped up to higher pressure over ˜30 seconds, and finally held for 1.5 minute at 20,000 PHI (Ram force in pounds).

Compression molded formulations were characterized for their appearance according to Example 4 and summarized in Table 19 below.

TABLE 19

| | | | | |
|---|---|---|---|---|
| | | Alkaline | L* against | |
| | Plasticizer | additive | a white | Delta |
| Material # | (wt %) | (wt %) | background | E |

| | | | |
|---|---|---|---|
| Laneta | (white surface) | 95.51 | 73.3 |

10 mil compression molded films

| | | | | |
|---|---|---|---|---|
| 100 | PEG400 (15) | Hydromagnesite (5) | 88.49 | 47.2 |
| 101 | PEG400 (15) | BMC (5) | 89.69 | 28.6 |

20 mil compression molded films

| | | | | |
|---|---|---|---|---|
| 102 | PEG400 (15) | Hydromagnesite (5) | 83.06 | 40.0 |
| 103 | PEG400 (15) | BMC (5) | 86.97 | 22.2 |

### Example 15. Appearance of Melt-Processed Formulations of Plasticized CA

Formulations with PEG400 as a plasticizer and 1 wt % to 5 wt % Hydromagnesite as an alkaline additive were compounded, and 30 mil films were extruded according to Example 2. The appearance of the 30 mil extruded films was characterized according to Example 4, and summarized in

TABLE 20

| | | Alkaline | L* against | |
|---|---|---|---|---|
| | Plasticizer | additive | a white | Delta |
| Sample # | (wt %) | (wt %) | background | E |
| Laneta | (white surface) | | 95.51 | 73.7 |
| 83 | PEG400 (15) | Hydromagnesite (1) | 89.29 | 52.2 |
| 84 | PEG400 (15) | Hydromagnesite (2) | 80.68 | 48.0 |
| 85 | PEG400 (15) | Hydromagnesite (5) | 56.37 | 37.2 |

### Example 16. Melt Processed Articles of CAP with Alkaline Additive

Compression molded CAP films: For control film samples without MgO, CE powder was used as is. For samples with MgO, 95 g of Eastman CAP-485-20 powder was mixed with 5 g MgO using a planetary mixer (Thinky mixer). The powder was then sieved to ensure the mixture is free of clumps. The powder was compression molded into a 30 mil film using a compression molder. CAP formulations with and without MgO were compression molded at 450 F for up to 4 minutes.

### Example 17. Melt Processed Articles of CAB with Alkaline Additive

Compression molded CAB films: For control film samples without MgO, CE powder was used as is. For samples with MgO, 95 g of Eastman CAB-381-2 powder was mixed with 5 g MgO using a planetary mixer (Thinky mixer). The powder was then sieved to ensure the mixture is free of clumps. The powder was compression molded into a 30 mil film using a compression molder. CAB formulations with and without MgO were compression molded at 420° F. for up to 4 minutes.

### Example 18. Survey of Metal Oxides, Hydroxides and Carbonates as Alkaline Additives

A selection of metal oxides hydroxides and carbonates were screened as alkaline additives to promote degradation of CA films (Table 21). Films were cast from acetone dope of CA-394-60S containing 12 wt % PEG400 and the mineral combinations described in Table 23. Weight loss from films after 12 weeks in deionized water at 50° C. was used to estimate environmental degradation of films. Only ZnO, Mg(OH)₂ and BMC were effective at increasing weight loss from films when included as the sole additive. Only Mg(OH)₂ and BMC were effective at increasing weight loss from films when combined with 15 wt % CaCO₃. The highest % wt loss in water at 50° C. was measured when films contained 15 wt % CaCO₃ and 5 wt % MgO plus 5 wt % Mg(OH)₂.

TABLE 21
Minerals screened as alkaline additives to
promote disintegration of cellulose esters.

| Abbreviation | Description | Source |
|---|---|---|
| Al₂O₃ | Aluminum oxide, nanopowder | Sigma 544833 |
| BZC | Basic Zinc Carbonate | Sigma 96466 |
| DHT-4C | Aluminum magnesium carbonate | Kyowa Chemical |
| | hydroxide, Dehydrated | Industry Co., Ltd. |
| | hydrotalcite | |
| ZnO | Zinc Oxide | Akrochem |
| BMC | Basic magnesium carbonate | Brenntag |
| Mg(OH)₂ | Magnesium hydroxide | Huber Vertex 100 |

TABLE 22
Formulations

| Sample # | Formulation |
|---|---|
| 100 | CA-394-60S, PEG400 (12 wt %) |
| 101 | CA-394-60S, PEG400 (12 wt %), CaCO₃ (15 wt %) |
| 102 | CA-394-60S, PEG400 (12 wt %), Al₂O₃ (5 wt %) |
| 103 | CA-394-60S, PEG400 (12 wt %), Al₂O₃ (5 wt %), |
| | CaCO₃ (15 wt %) |
| 104 | CA-394-60S, PEG400 (12 wt %), Al₂O₃ (5 wt %), |
| | MgO (5 wt %) |
| 105 | CA-394-60S, PEG400 (12 wt %), Al₂O₃ (5 wt %), |
| | CaCO₃ (15 wt %), MgO (5 wt %) |
| 106 | CA-394-60S, PEG400 (12 wt %), BZC (5 wt %) |
| 107 | CA-394-60S, PEG400 (12 wt %), BZC (5 wt %), |
| | CaCO₃ (15 wt %) |
| 108 | CA-394-60S, PEG400 (12 wt %), BZC (5 wt %), |
| | MgO (5 wt %) |
| 109 | CA-394-60S, PEG400 (12 wt %), BZC (5 wt %), |
| | CaCO₃ (15 wt %), MgO (5 wt %) |
| 110 | CA-394-60S, PEG400 (12 wt %), DHT-4C (5 wt %) |
| 111 | CA-394-60S, PEG400 (12 wt %), DHT-4C (5 wt %), |
| | CaCO₃ (15 wt %) |
| 112 | CA-394-60S, PEG400 (12 wt %), DHT-4C (5 wt %), |
| | MgO (5 wt %) |
| 113 | CA-394-60S, PEG400 (12 wt %), DHT-4C (5 wt %), |
| | CaCO₃ (15 wt %), MgO (5 wt %) |
| 114 | CA-394-60S, PEG400 (12 wt %), ZnO (5 wt %) |
| 115 | CA-394-60S, PEG400 (12 wt %), ZnO (5 wt %), |
| | CaCO₃ (15 wt %) |
| 116 | CA-394-60S, PEG400 (12 wt %), ZnO (5 wt %), |
| | MgO (5 wt %) |
| 117 | CA-394-60S, PEG400 (12 wt %), ZnO (5 wt %), |
| | CaCO₃ (15 wt %), MgO (5 wt %) |
| 118 | CA-394-60S, PEG400 (12 wt %), BMC (5 wt %) |
| 119 | CA-394-60S, PEG400 (12 wt %), BMC (5 wt %), |
| | CaCO₃ (15 wt %) |
| 120 | CA-394-60S, PEG400 (12 wt %), BMC (5 wt %), |
| | MgO (5 wt %) |
| 121 | CA-394-60S, PEG400 (12 wt %), BMC (5 wt %), |
| | CaCO₃ (15 wt %), MgO (5 wt %) |
| 122 | CA-394-60S, PEG400 (12 wt %), Mg(OH)₂ (5 wt %) |
| 123 | CA-394-60S, PEG400 (12 wt %), Mg(OH)₂ (5 wt %), |
| | CaCO₃ (15 wt %) |
| 124 | CA-394-60S, PEG400 (12 wt %), Mg(OH)₂ (5 wt %), |
| | MgO (5 wt %) |
| 125 | CA-394-60S, PEG400 (12 wt %), Mg(OH)₂ (5 wt %), |
| | CaCO₃ (15 wt %), MgO (5 wt %) |

TABLE 23
Weight loss from films at 12 weeks.
Sample # (% wt loss from film after 12 weeks at 50° C.)

| | 5 wt % Test | 5 wt % Test | 5 wt % Test |
|---|---|---|---|
| 5 wt % | Mineral plus | Mineral plus | Mineral plus |
| Test | 15 wt % | 5 wt % | (15 wt % CaCO₃ + |
| Mineral | CaCO₃ | MgO | 5 wt % MgO) |
| 100 (13.4) | 101 (15.8) | — | — |
| 102 (11.2) | 103 (14.2) | 104 (23.5) | 105 (26.1) |
| 106 (11.3) | 107 (13.7) | 108 (26.3) | 109 (29.7) |
| 110 (12.2) | 111 (14.9) | 112 (24.5) | 113 (29.1) |
| 114 (14.8) | 115 (15.4) | 116 (29.3) | 117 (28.7) |
| 118 (18.4 | 119 (20.2) | 120 (30.5) | 121 (34.6) |
| 122 (18.9) | 123 (24.4) | 124 (36.1) | 125 (38.4) |

### Example 19. CaCO₃ in Combination with MgO and/or Mg(OH)₂

Films were cast from acetone dope of CA-394-60S containing 12 wt % PEG400 and the mineral combinations described in Table 25. Weight loss from films, a prediction of environmental degradation, is maximized with a combination of Calcium carbonate (CaCO₃) from multiple sources, and 5 wt % MgO, or a combination of 5 wt % MgO and 5 wt % Mg(OH)₂. In contrast, degradation of films measured as weight loss, was not improved by including the neutral filler kaolin.

TABLE 24

| Sample # | Formulation |
|---|---|
| 126 | CA-394-60S, PEG400 (12 wt %), MgO (5 wt %) |
| 127 | CA-394-60S, PEG400 (12 wt %), Mg(OH)₂ (5 wt %) |
| 128 | CA-394-60S, PEG400 (12 wt %), MgO (5 wt %), |
| | Mg(OH)₂ (5 wt %) |
| 129 | CA-394-60S, PEG400 (12 wt %), MgO (5 wt %), |
| | Burgess #20 kaolin (neutral) (20 wt %) |
| 130 | CA-394-60S, PEG400 (12 wt %), Mg(OH)₂ (5 wt %), |
| | Burgess #20 kaolin (neutral) (20 wt %) |
| 131 | CA-394-60S, PEG400 (12 wt %), MgO (5 wt %), |
| | Mg(OH)₂ (5 wt %), Burgess #20 kaolin (neutral) (20 wt %) |
| 132 | CA-394-60S, PEG400 (12 wt %), MgO (5 wt %), |
| | Imerys Gamaco CaCO₃ (20 wt %) |
| 133 | CA-394-60S, PEG400 (12 wt %), Mg(OH)₂ (5 wt %), |
| | Imerys Gamaco CaCO₃ (20 wt %) |
| 134 | CA-394-60S, PEG400 (12 wt %), MgO (5 wt %), |
| | Mg(OH)₂ (5 wt %), Imerys Gamaco CaCO₃ (20 wt %) |
| 135 | CA-394-60S, PEG400 (12 wt %), MgO (5 wt %), |
| | Imerys Heliacal 3000 CaCO₃ (20 wt %) |
| 136 | CA-394-60S, PEG400 (12 wt %), Mg(OH)₂ (5 wt %), |
| | Imerys Heliacal 3000 CaCO₃ (20 wt %) |
| 137 | CA-394-60S, PEG400 (12 wt %), MgO (5 wt %), |
| | Mg(OH)₂ (5 wt %), Imerys Heliacal 3000 |
| | CaCO₃ (20 wt %) |
| 138 | CA-394-60S, PEG400 (12 wt %), MgO (5 wt %), |
| | Huber Optifil CaCO₃ (20 wt %) |
| 139 | CA-394-60S, PEG400 (12 wt %), Mg(OH)₂ (5 wt %), |
| | Huber Optifil CaCO₃ (20 wt %) |
| 140 | CA-394-60S, PEG400 (12 wt %), MgO (5 wt %), |
| | Mg(OH)₂ (5 wt %), Huber Optifil |
| | CaCO₃ (20 wt %) |
| 141 | CA-394-60S, PEG400 (12 wt %), MgO (5 wt %), |
| | OMYA Smartfill 50-L CaCO₃ (20 wt %) |
| 142 | CA-394-60S, PEG400 (12 wt %), Mg(OH)₂ |
| | (5 wt %), OMYA Smartfill 50-L |
| | CaCO₃ (20 wt %) |
| 143 | CA-394-60S, PEG400 (12 wt %), MgO (5 wt %), |
| | Mg(OH)₂ (5 wt %), OMYA Smartfill 50-L |
| | CaCO₃ (20 wt %) |

TABLE 25
% wt loss from films at 12 weeks
Sample # (% wt loss from film after 12 weeks at 50° C.)

| | | 20% Filler (2 wt %), |
|---|---|---|
| Filler (20 wt %), | Filler (20 wt %), | MgO (5 wt %), |
| MgO (5 wt %) | Mg(OH)₂ (5 wt %) | Mg(OH)₂ (5 wt %) |
| 126 (25.6) | 127 (24.1) | 128 (37.6) |
| (no filler) | (no filler) | (no filler) |
| 129 (26.3) | 130 (25.1) | 131 (37.0) |
| 132 (31.7) | 133 (27.0) | 134 (38.5) |
| 135 (35.8) | 136 (28.2) | 137 (42.4) |
| 138 (30.3) | 139 (26.9) | 140 (40.2) |
| 141 (30.9) | 142 (25.9) | 143 (42.2) |

### Example 20. Varying the Ratio of MgO to Mg(OH)₂ in Mixtures with CaCO₃

Films were cast from acetone dope of CA-394-60S containing 12 wt % PEG400 and the mineral combinations described in Table 26. Weight loss from films after 12 weeks in deionized water at 50° C., a prediction of environmental degradation, is increased by combining alkaline additives MgO and/or Mg(OH)₂ with CaCO₃.

TABLE 26
% wt loss from films at 12 weeks

| Mineral blend in films | | | |
|---|---|---|---|
| (wt % of formulation) | | | % wt |
| CaCO₃ | Mg(OH)₂ | MgO Marinco | loss @12 |
| Heliacal | Vertex100 | FCC | weeks |
| 15 | | | 12.9 |
| 25 | | | 16.0 |
| | 5 | | 21.2 |
| | | 5 | 23.9 |
| 15 | 5 | | 26.0 |
| 25 | 5 | | 28.2 |
| 15 | | 5 | 32.0 |
| 25 | | 5 | 32.5 |
| 15 | 5 | 5 | 40.0 |
| 25 | 5 | 5 | 39.3 |

### Example 21. Varying the Ratio of MgO to Mg(OH)₂ in Mixtures with CaCO₃

Films were cast from acetone dope of CA-394-60S containing 12 wt % PEG400 and the mineral combinations described in Table 27. Weight loss from films after 12 weeks in deionized water at 50° C., a prediction of environmental degradation, is varies only slightly at different ratios of the alkaline additives MgO and Mg(OH)₂ with CaCO₃.

TABLE 27
% wt loss from films at 12 weeks

| Mineral blend in films | | | |
|---|---|---|---|
| (wt % of formulation) | | | % wt |
| CaCO₃ | Mg(OH)₂ | MgO | loss, 12 |
| Heliacal | Vertex100 | Marinco FCC | weeks |
| 15 | 0 | 10 | 41.1 |
| 15 | 2 | 8 | 41.2 |
| 15 | 4 | 6 | 40.7 |
| 15 | 6 | 4 | 39.8 |
| 15 | 8 | 2 | 39.9 |
| 15 | 10 | 0 | 38.5 |

### Example 22: Preferred Neutralizing Agents are Heat-Stable Carboxylic Acids

Dry blends were made for compression molding. First, CA398-30 and MgO (Marinco FCC) were pre-sieved separately to remove lumps, then combined in the required ratio (158 g CA+10 g MgO) and sieved together 3 times to disperse well. To avoid variations in MgO content, this CA:MgO master blend was used for all subsequent blends. To incorporate the acids, about a gram of solid was ground in a mortar & pestle to a fine powder. Each ground acid was pre-sieved separately, then 0.3 grams of acid was combined with the CA:MgO pre-blend, and sieved together 3 times to disperse the acid. Finally, PEG400 was added to the powder and the final blend was mixed in a coffee grinder to disperse the PEG400. Each complete dry blend was pre-weighed (5.5 g) into aluminum pans and dried for 16 h at 70° C. Each complete blend contained: 79 wt % CA-398-30; 15 wt % PEG400; 5 wt % MgO and 1 wt % acid (or none).

Films were pressed for a total of 4 minutes on a heated press with the upper and lower platens pre-heated to 425° F. (218° C.). The pre-dried CA/PEG400/MgO/acid dry blend was applied to the center of a 4-inch square, 10 mil thick frame between a top and bottom layer of aluminum foil, all between two steel plates. The assembly was placed in the press and heated for 1 min at 0 pressure to dry and pre-melt the puck, then pressed for 1 minute at 12,000 PHI, bumped up to higher pressure over ˜30 seconds, and finally held for 1.5 minute at 20,000 PHI (Ram force in pounds).

Observations on the appearance of compression molded films is included in Table 28. In thin films composed of CA, 15 wt % PEG400 and 5 wt % MgO molded at 425° F./218° C., a characteristic dark brown color and burnt odor forms in the absence of a neutralizing acid. When 1 wt % citric acid is included, the color is much lighter, but bubble-like defects appear, thought to be caused by water vapor formed during thermal dehydration of citric acid. The citric acid used in the formulation is anhydrous. The other acids yielded mixed results. Both Benzoic acid and Aspartic acid were poor neutralizing additives when paired with MgO in compression molded films. The films formed a dark color during molding and a strong odor. In contrast, molded films with either Adipic acid or Fumaric acid at 1 wt % had a lighter color with no obvious sign of thermal decomposition.

TABLE 28
Organic acids formulated into dry blends with CA-
398-30, 15 wt % PEG400 and 5 wt % MgO and resulting
appearance of compression molded films.

| Acid | | Pressed | Notes on |
|---|---|---|---|
| (1 wt %) | Source | films | appearance |
| None | | Unacceptable | Dark color, mild odor (burnt) |
| Citric | Sigma- | Good | Light color, very mild odor, |
| | Aldrich | | signs of thermal decomposition |
| | W230633 | | (bubbles) |
| Adipic | Aldrich | Good | Light color, mild odor, |
| | 24,052-4 | | good flow |
| | (DuPont) | | |
| Fumaric | Sigma- | Good | Light color, very mild odor, |
| | Aldrich | | good flow, easy release |
| | 47910 | | from the foil |
| L-Aspartic | Sigma | Unacceptable | Medium brown color, Strong |
| | A9256 | | odor (burnt tobacco) |
| Benzoic | Alfa Aesar | Unacceptable | Very dark brown color, |
| | A14062 | | Moderate odor |

### Disintegration in Compost

### Example 23. Disintegration in Home Compost Bins

Injection molded knives made from different formulations were added to residential compost bins to monitor disintegration in home compost. The dimensions of molded cutlery serving as Controls and Test formulations of the invention are detailed in Table 29.

TABLE 29
Dimensions of control and test articles.

| | | Thickness (mm) | | | | |
|---|---|---|---|---|---|---|
| | | | Thickest | Dimensions (mm) | | |
| | | Edge of | part of | | Width | Width |
| KNIVES | Weight | blade | handle | Length | (widest) | (narrowest |
| PS | 4 grams | 1.4 | 3.8 | 166 | 17 | 10 |
| PLA | 5 grams | 1.3 | 3.0 | 171 | 18 | 8 |
| TEST | 6 grams | 1.4 | 3.4 | 168 | 18 | 9 |

Compost bins were 140 L capacity black plastic household tumblers, initially filled with about 100 L of feedstock (70 L Mature compost, 24 L pine shavings, 4-5 L Alfalfa pellets, 60% moisture). Adjust initial C:N ratio to >2 with alfalfa pellets and/or KNO₃. The side vents were opened fully. Feedstock was added to empty bins. The starting feedstock volume was about 100 L.

TABLE 30

| Material | Amount |
|---|---|
| Mature industrial compost | to the center axis |
| (locally sourced) | (about 70 liters) |
| Alfalfa pellets | 4-5 Liters |
| (adult rabbit food) | |
| Pine shavings | 22 L bag, up to about |
| (pet bedding) | the target volume |
| Water | To ~60% moisture by |
| | squeeze test |

Test articles were labeled with colored tape and added to the bins. Bins were tumbled weekly and moisture level maintained using the squeeze test. Compost was fed ˜1 L of alfalfa at 8, 14, 20, 26 weeks. Pine shaving were added to keep the compost volume at or above the center axis. Disintegration of articles in the home compost bins was monitored as weight loss from dried articles collected from the bin. After 26 weeks in the home compost bins, the final % weight loss was determined. Only articles with a combination of the alkaline minerals CaCO₃ and MgO reached a target of >90% weight loss after 26 weeks.

TABLE 31
Disintegration of control and test articles.

| | | % wt |
|---|---|---|
| | | loss after |
| | | 26 weeks |
| Article | Formulation | (avg, n = 9) |
| PS | Polystyrene (Staple's brand) | −2.0 |
| PLA | PLA (Earth's Natural Alternative); | −1.6 |
| | Bpi certified #10528737 | |
| TEST 88 | CA-398-30 (85 wt %), PEG400 (15 wt %) | 25.8 |
| TEST 120 | CA-398-30 (78 wt %), PEG400 (12 wt %), | 36.1 |
| | CaCO₃ (10 wt %) | |
| TEST 90 | CA-398-30 (79.5 wt %), PEG400 (15 wt %), | 72.3 |
| | Mg(OH)₂ (5 wt %), citric acid (0.5 wt %) | |
| TEST 89 | CA-398-30 (79 wt %), PEG400 (15 wt %), | 82.5 |
| | MgO (5 wt %), citric acid (1 wt %) | |
| TEST 112 | CA-398-30 (67 wt %), PEG400 (12 wt %), | 95.0 |
| | MgO (5 wt %), CaCO₃ (15 wt %), | |
| | citric acid (1 wt %) | |
| TEST 113 | CA-398-30 (67 wt %), PEG400 (12 wt %), | 95.5 |
| | MgO (5 wt %), CaCO₃ (15 wt %), | |
| | citric acid (1 wt %) | |

### Example 24. Disintegration of According to ISO20200 at Elevated Temperature

The American standard ASTM D6400 Standard Specification for Labeling of Plastics Designed to be Aerobically Composted in Municipal or Industrial Facilities (2021), defines a 90% minimum disintegration requirement for certification.

Test articles were forks molded from a formulation containing 66 wt % CA-394-60S, 12 wt % PEG400, 5 wt % MgO, 15 wt % CaCO₃ and 1 wt % citric acid. The test article varied in thickness from 1.5 mm at the tip of the handle to 3.7 mm at the thickest part of the handle. Disintegration of test articles in lab compost was conducted according to ISO 20200. A synthetic compost included rabbit feed, corn starch, sugar, corn oil, urea, saw dust, and wood chips. This feedstock was inoculated using a mature compost from a local industrial composting facility. The initial C:N ratio of 30:1 was adjusted with urea, and water added to adjust the moisture content to 55%. Test articles (14.6 grams) were added to each reaction vessel along with 1 kg of the synthetic compost mix. Reactors were run in triplicate. The mixture was composted for 12 weeks and the temperature was controlled at 58 deg C.+/−2. The average % disintegration across the three vessels was 99.4%.

### Example 25. Disintegration According to ISO 20200 at Ambient Temperature

The French standard specification NF T51-800 Plastics-Specifications for plastics suitable for home composting (2015), the Australian standard specification AS 5810 Biodegradable plastics-Biodegradable plastics suitable for home composting (2010) and the OK compost HOME certification scheme of TÜV AUSTRIA Belgium stipulate that a material has demonstrated sufficient disintegration for home composting when after 26 weeks of composting at least 90% of the test material has reduced to a size <2 mm in a quantitative test according to ISO 20200 (2015) at ambient temperature (20° C.-30° C.).

A test formulation containing CA-394-60S (66 wt %), PEG400 (12 wt %), MgO (5 wt %), CaCO₃ (15 wt %) and citric acid (1 wt %) was used to molded a fork with dimensions ranging from 0.84 mm at the thinnest part (center of handle) to 1.89 mm at the thickest part (neck). Disintegration of the article in home compost was tested according to ISO 20200 “Plastics-Determination of the degree of disintegration of plastic materials under simulated composting conditions in a laboratory-scale test” (2015). The test was modified by incubating the test sample and compost at 28° C.±2° C. in order to simulate home composting conditions. The synthetic compost mixture included 2 kg of the <10 mm fraction of mature compost plus fresh milled Vegetable, Garden and Fruit waste per reactor. Disintegration of the article was 90.1% after 26 weeks.

That which is claimed:

1. A cellulose acetate tow band comprising a cellulose acetate composition; at least one cellulose acetate, at least one plasticizer, at least one alkaline additive, and at least one neutralizing agent; wherein a 1% suspension of said alkaline addition has a pH of 8 or greater; wherein the water-solubility of said alkaline filler at 20-25 C is greater than 1 ppm but less than 1,000 ppm; and wherein said alkaline filler is present in an amount of about 0.1% to about 10% based on the weight of the cellulose ester composition.

2. The cellulose acetate tow band according to claim 1 wherein said cellulose acetate has a DS/AGU of about 1 to about 2.5.

3. The cellulose acetate tow band according to claim 1 wherein said cellulose acetate is cellulose diacetate having a polystyrene equivalent number average molecular weights (Mn) from 10,000 to 90,000.

4. The cellulose acetate tow band according to claim 1 wherein said cellulose acetate is prepared by converting cellulose to a cellulose acetate with reactants that are obtained from recycled materials.

5. The cellulose acetate tow band according to claim 1 wherein said plasticizer is at least one selected from the group consisting of glycerol triacetate (Triacetin), glycerol diacetate, dibutyl terephthalate, dimethyl phthalate, diethyl phthalate, poly(ethylene glycol) MW 200-600, triethylene glycol dipropionate, 1,2-epoxypropylphenyl ethylene glycol, 1,2-epoxypropyl(m-cresyl) ethylene glycol, 1,2-epoxypropyl(o-cresyl) ethylene glycol, β-oxyethyl cyclohexenecarboxylate, bis(cyclohexanate) diethylene glycol, triethyl citrate, polyethylene glycol, Benzoflex, propylene glycol, polysorbate, sucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, tripropionin, sucrose acetate isobutyrate, the Resolflex™ series of plasticizers, triphenyl phosphate, glycolates, methoxy polyethylene glycol, 2,2,4-trimethylpentane-1,3-diyl bis(2-methylpropanoate), and polycaprolactones.

6. The cellulose acetate tow band according to claim 1 wherein said plasticizer is present in an amount from 1 to 40 wt %.

7. The cellulose acetate tow band according to claim 1 wherein said plasticizer is selected from the group consisting of PEG and MPEG (methoxy PEG).

8. The cellulose acetate tow band according to claim 1 wherein said cellulose ester composition comprises a biodegradable cellulose ester (BCE) component and at least one other biodegradable polymer other than the BCE.

9. The cellulose acetate tow band according to claim 1 wherein said alkaline filler is at least one selected from the group consisting of metal oxides, metal hydroxides and metal carbonates.

10. The cellulose acetate tow band according to claim 1 wherein said alkaline filler is at least one selected from the group consisting of alkaline-earth metal oxides, alkaline-earth metal hydroxides and alkaline-earth carbonates.

11. The cellulose acetate tow band according to claim 1 wherein the pH of a 1 wt % solution or suspension of said alkaline filler ranges from about 8 to about 12.

12. The cellulose acetate tow band according to claim 1 wherein the water-solubility of said alkaline filler at 20-25 C is about 2 ppm to about 400 ppm.

13. The cellulose acetate tow band according to claim 1 wherein the pH of a 1% suspension of the alkaline filler is 8 or greater, and the alkaline efficiency is at least 5.

14. The cellulose acetate tow band according to claim 1 wherein the alkaline efficiency is at least 6.

15. The cellulose acetate tow band according to claim 1 wherein the alkaline filler is at least one selected from the group consisting of calcium carbonate (CaCO₃), magnesium oxide (MgO), magnesium hydroxide (Mg(OH)₂), magnesium carbonate (MgCO₃), barium carbonate (BaCO₃), and hydrated forms of these compounds.

16. The cellulose acetate tow band according to claim 1 wherein said alkaline filler undergoes volumetric expansion.

17. The cellulose acetate tow band according to claim 1 wherein said alkaline filler is present at between about 0.1% and about 10% in said cellulose ester composition by weight.

18. The cellulose acetate tow band according to claim 1 wherein said neutralizing agent is at least one selected from the group consisting of citric acid, malic acid, succinic acid, adipic acid, fumaric acid, formic acid, lactic acid, maleic acid, tartaric acid, malonic acid, glutamic acid, glutaric acid, gluconic acid, isophthalic acid, terephthalic acid, glycolic acid, itaconic acid, ferulic acid, mandelic acid, aconitic acid, benzoic acid, aspartic acid, and vanillic acid.

19. The cellulose ester tow band according to claim 1 wherein about 0.5 wt % to about 5 wt % of the neutralizing agent is present in said cellulose acetate composition based on the weight of the cellulose acetate composition.
